(19) United States
(12) Patent Application Publication
(10) Pub. No.: US 2011/0072618 A1
(43) Pub. Date: Mar. 31, 2011

(54) HINGE DEVICE

(76) Inventor: Saflok Chen, Taichung City (TW)

(21) Appl. No.: 12/567,554

(22) Filed: Sep. 25, 2009

(51) Int. Cl. E05F 1/08

(52) U.S. Cl. 16/303

(57) ABSTRACT

A hinge device includes first and second leaves provided respectively with first and second knuckles coupled pivotally to each other, a torsion spring having an end connected to the second knuckle, cam co-rotatable with the first knuckle, and a cam follower disposed in the first knuckle and coupled to an opposite end of the torsion spring. The first knuckle and the cam are rotatable in a first rotational direction for driving the cam to engage the cam follower and for rotating the cam follower so as to twist the torsion spring. The cam follower can be driven by a restoring force of the torsion spring to rotate in a second rotational direction opposite to the first rotational direction to drive the cam and the first knuckle to rotate in the second rotational direction, and is operable to rotate in the first rotational direction for twisting the torsion spring.

### BACKGROUND OF THE INVENTION

1. Field of the Invention

This invention relates to a hinge device, more particularly to a hinge device including a torque-adjustable torsion spring.

2. Description of the Related Art

FIG. 1 illustrates a conventional hinge device that includes a first leaf 11 mounted to a door panel (not shown) and provided with a first knuckle 111, a second leaf 12 mounted to a door frame (not shown) and provided with a second knuckle 121 coupled to the first knuckle 111 through a pivot pin 14, a washer 13 disposed between the first and second knuckles 111, 121 for facilitating the rotation of the first knuckle 111 relative to the second knuckle 121, a cylindrical part 17 disposed in the second knuckle 121, and a torsion spring 16 disposed in the second knuckle 121 and having one end connected to a rod 141 of the pivot pin 14 and the other end connected to the cylindrical part 17. The pivot pin 14 is locked in the first knuckle 111 by two lock bolts 15 (only one is shown). The cylindrical part 17 is formed with a plurality of fastening holes 172, and the second knuckle 121 is formed with a circumferentially extended slide groove 122 that is registered with some of the fastening holes 172. A screw 18 is extended through the slide groove 122 and engages threadedly a selected one of the fastening holes 172.

During the door-opening process, the first leaf 11 is pivoted relative to the second leaf 12, such that the first knuckle 111 is driven to rotate relative to the second knuckle 121, thereby twisting the torsion spring 16. Afterward, a restoring force of the torsion spring 16 automatically drives the first knuckle 111 to rotate reversely relative to the second knuckle 121 to thereby result in an automatic reverse pivoting movement of the first leaf 11 relative to the second leaf 12. Moreover, before the door-opening process, torque of the torsion spring 16 can be adjusted by removing the screw 18 from an initial fastening hole 172, and engaging the screw 18 to another fastening hole 172.

However, since the screw 18 slides along the slide groove 122 as the cylindrical part 17 rotates during the abovementioned torque-adjusting process, the torque of the torsion spring 16 can only be adjusted in a limited extent depending upon the length of the slide groove 122. Moreover, if the door panel is relatively heavy, it will exert a relatively large pressure to the torsion spring 16 to thereby result in damage to the torsion spring 16 after long-term use. Furthermore, the relatively heavy door panel will also result in a relatively large friction between the washer 13 and the first and second knuckles 111, 121, thereby hindering the rotation of the first knuckle 111 relative to the second knuckle 121.

### SUMMARY OF THE INVENTION

Therefore, the object of the present invention is to provide a hinge device that can overcome at least one of the aforesaid drawbacks associated with the prior art.

According to this invention, a hinge device comprises a hinge unit, a torque-providing unit; and a torque-adjusting unit. The hinge unit includes a first leaf, a second leaf, and a knuckle unit that includes first and second knuckles provided respectively to the first and second leaves and coupled pivotally to each other such that the first leaf is rotatable relative to the second leaf. The first and second knuckles define cooperatively a channel unit that extends along an axis. The torque-providing unit includes a torsion spring that is disposed in the channel unit, and that has a first end secured to the second knuckle and a second end opposite to the first end. The torque-adjusting unit includes a cam mechanism that includes a cam coupled co-rotatably to the first knuckle, and a cam follower disposed rotatably in the first knuckle and coupled co-rotatably to the second end of the torsion spring of the torque-providing unit. The first knuckle and the cam are rotatable in a first rotational direction relative to the second knuckle as a result of application of a force to the first leaf so as to drive the cam to engage the cam follower and to drive the cam follower to rotate in the first rotational direction, thereby twisting the torsion spring. When the force is released, the cam follower is driven by a restoring force of the torsion spring to rotate in a second rotational direction opposite to the first rotational direction so as to drive the cam to rotate in the second rotational direction, thereby driving the first knuckle to rotate in the second rotational direction relative to the second knuckle. The cam follower is operable to rotate in the first rotational direction so as to twist the torsion spring, thereby adjusting the torque of the torsion spring.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a conventional hinge device;

FIG. 2 is an exploded perspective view of a first preferred embodiment of a hinge device according to this invention;

FIG. 3 is an assembled top view of the first preferred embodiment;

FIG. 4 is a sectional view of the first preferred embodiment;

FIG. 5 is another sectional view of the first preferred embodiment taken along line 5-5 in FIG. 3;

FIG. 6 is still another sectional view of the first preferred embodiment taken along line 6-6 in FIG. 3;

FIG. 7 is an exploded perspective view of a torque-adjusting unit and a resilient member of a friction-providing unit of the first preferred embodiment;

FIG. 8 is an exploded perspective view of the torque-adjusting unit and a modified resilient member of the friction-providing unit of the first preferred embodiment;

FIGS. 9 to 22 illustrate an assembling process of the first preferred embodiment;

FIG. 23 is an exploded perspective view of a second preferred embodiment of the hinge device according to the invention;

FIG. 24 is a sectional view of the second preferred embodiment;

FIG. 25 is another sectional view of the second preferred embodiment taken along line 25-25 in FIG. 24;

FIG. 26 is an exploded perspective view of a third preferred embodiment of the hinge device according to the invention;

FIG. 27 is a sectional view of the third preferred embodiment;

FIG. 28 is an exploded perspective view of a fourth preferred embodiment of the hinge device according to the invention;

FIG. 29 is an assembled top view of the fourth preferred embodiment;

FIG. 30 is a sectional view of the fourth preferred embodiment taken along line 30-30 in FIG. 29;

FIG. 31 is another sectional view of the fourth preferred embodiment taken along line 31-31 in FIG. 29;

FIG. 32 is an exploded perspective view of a fifth preferred embodiment of the hinge device according to the invention;

FIG. 33 is a sectional view of the fifth preferred embodiment;

FIG. 34 is an exploded perspective view of a sixth preferred embodiment of the hinge device according to the invention;

FIG. 35 is a sectional view of the sixth preferred embodiment;

FIG. 36 is another sectional view of the sixth preferred embodiment taken along line 36-36 in FIG. 35;

FIG. 37 is a partly sectional view of a seventh preferred embodiment of the hinge device according to the invention, illustrating a first leaf at a zero-degree angular position relative to a second leaf;

FIG. 38 is a side view of the seventh preferred embodiment, illustrating the first leaf at the zero-degree angular position relative to the second leaf;

FIG. 39 is an exploded perspective view of a friction-providing unit of the seventh preferred embodiment;

FIG. 40 is another side view of the seventh preferred embodiment, illustrating the first leaf at a 45-degree angular position relative to the second leaf;

FIG. 41 is another partly sectional view of the seventh preferred embodiment, illustrating the first leaf at the 45-degree angular position relative to the second leaf;

FIG. 42 is a sectional view of an eighth preferred embodiment of the hinge device according to the invention, illustrating a first leaf at a zero-degree angular position relative to a second leaf;

FIG. 43 is an exploded perspective view of a friction-providing unit of the eighth preferred embodiment;

FIG. 44 is another partly sectional view of the eighth preferred embodiment, illustrating the first leaf at a 45-degree angular position relative to the second leaf;

FIG. 45 is an exploded perspective view of a ninth preferred embodiment of the hinge device according to the invention;

FIG. 46 is a sectional view of the ninth preferred embodiment;

FIG. 47 is another sectional view of the ninth preferred embodiment taken along line 47-47 in FIG. 46;

FIG. 48 is still another sectional view of the ninth preferred embodiment taken along line 48-48 in FIG. 47;

FIG. 49 is an exploded perspective view of a tenth preferred embodiment of the hinge device according to the invention;

FIG. 50 is a sectional view of the tenth preferred embodiment;

FIG. 51 is another sectional view of the tenth preferred embodiment taken along line 51-51 in FIG. 50; and

FIG. 52 is still another sectional view of the tenth preferred embodiment taken along line 52-52 in FIG. 51.

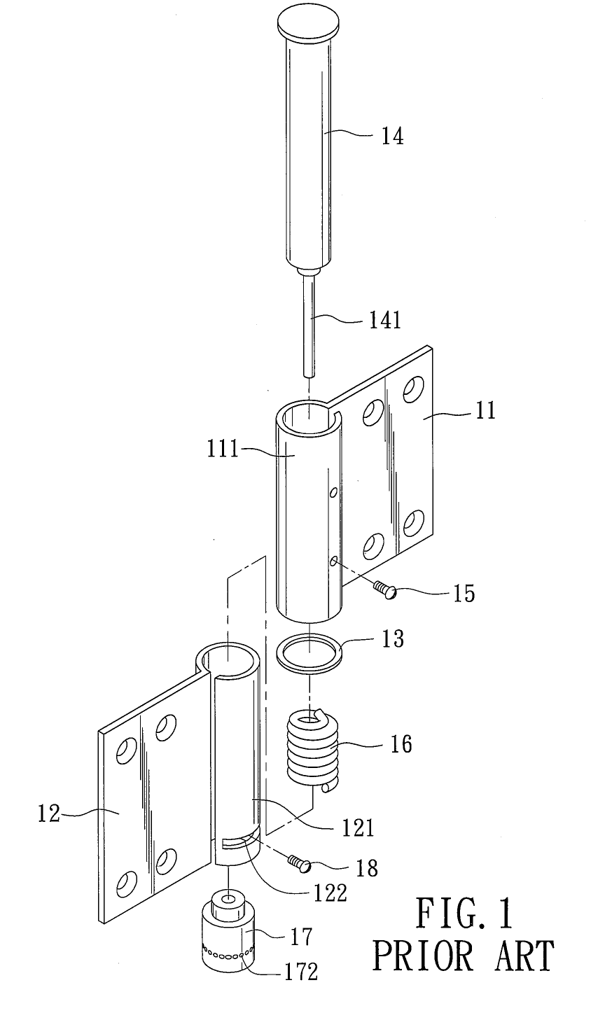

### DETAILED DESCRIPTION OF THE PREFERRED EMBODIMENTS

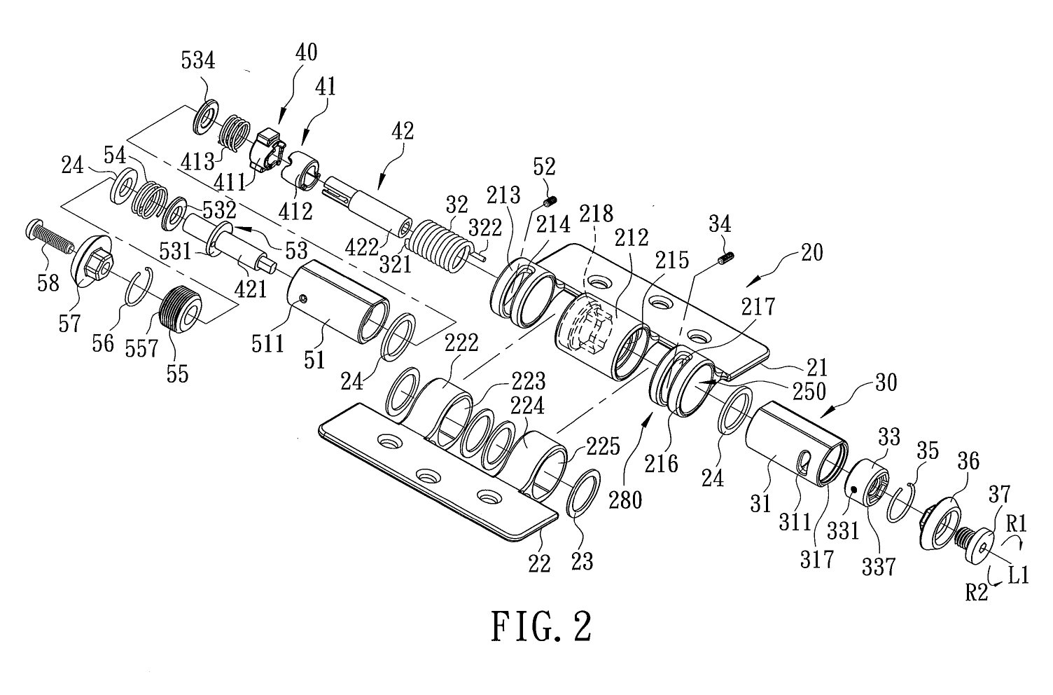

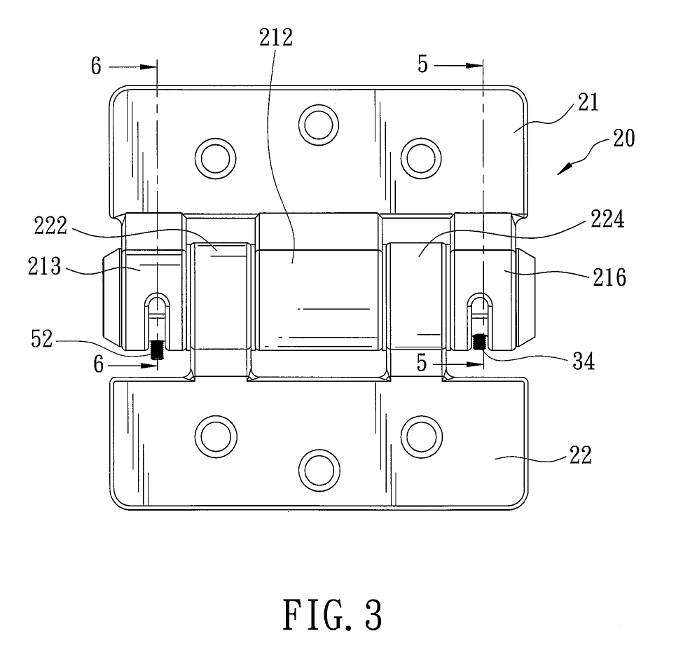

Referring to FIGS. 2 to 4, the first preferred embodiment of a hinge device according to the present invention includes a hinge unit 20, a torque-providing unit 30, a torque-adjusting unit 40, and a friction-providing unit 50.

The hinge unit 20 includes a first leaf 21 adapted to be mounted to a door panel (not shown), a second leaf 22 adapted to be mounted to a door frame (not shown), and a knuckle unit 280. The knuckle unit 280 includes a first knuckle 212, a pair of circular outer knuckles 213, 216, and a pair of second knuckles 222, 224. The first knuckle 212 and the outer knuckles 213, 216 are provided to the first leaf 21. The second knuckles 222, 224 are provided to the second leaf 22. The second knuckle 222 is disposed between and is coupled pivotally to the first knuckle 212 and the outer knuckle 213, and the second knuckle 224 is disposed between and is coupled pivotally to the first knuckle 212 and the outer knuckle 216, such that the first leaf 21 is pivotable relative to the second leaf 22. The first knuckle 212, the outer knuckles 213, 216, and the second knuckles 222, 224 define cooperatively a channel unit 250 that extends along an axis (L1). In this embodiment, the outer knuckles 213, 216 are formed respectively with first and second grooves 214, 217, each of which extends circumferentially by 180 degrees. The first knuckle 212 has an internal surface with axially opposite ends that are adjacent respectively to the second knuckles 222, 224 and that are formed respectively with a pair of stepped surface portions 218, 215. In this embodiment, a portion of the channel unit 250 within the second knuckle 222 is an elliptical channel portion 223, and another portion of the channel unit 250 within the second knuckle 224 is also an elliptical channel portion 225. The hinge unit 20 further includes a plurality of spacer components 23 each disposed between a corresponding adjacent pair of the first knuckle 212, the outer knuckles 213, 216 and the second knuckles 222, 224, such that the first leaf 21 can be pivoted smoothly relative to the second leaf 22. In this embodiment, each of the spacer components 23 is made mainly of polytetrafluoroethylene (PTFE).

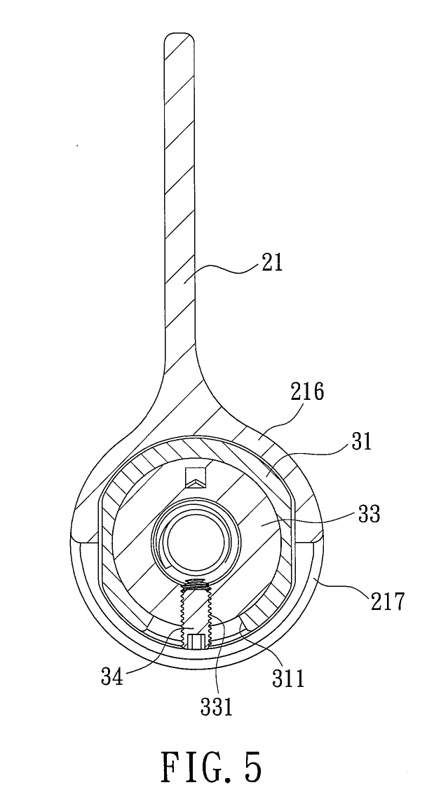

The torque-providing unit 30 includes a first barrel 31, a torsion spring 32, a positioning nut 33, a threaded limiting component 34, a first C-ring 35, a first enclosing component 36, and a first enclosing bolt 37. The first barrel 31 extends in the outer knuckle 216 and the second knuckle 224 of the hinge unit 20, and has an elliptical barrel body extending fittingly into the elliptical channel portion 225 in the second knuckle 224 so as to be secured to the second knuckle 224. Since the outer knuckle 216 is circular, it can be rotated freely relative to the first barrel 31. The barrel body of the first barrel 31 is formed with a through hole 311 registered with the second groove 217 in the outer knuckle 216. The torsion spring 32 is disposed in the first barrel 31 and has opposite first and second ends 322, 321. The positioning nut 33 is disposed in the first barrel 31, is secured to the first end 322 of the torsion spring 32, and is formed with a threaded positioning hole 331 registered with the second groove 217 in the outer knuckle 216 and the through hole 311 in the barrel body of the first barrel 31. Referring further to FIG. 5, the threaded limiting component 34 extends threadedly through the threaded positioning hole 331 in the positioning nut 33, and has one end opposite to the positioning nut 33 and extending outwardly of the second groove 217 via the through hole 311 for maintaining the positioning nut 33 at an axial position relative to the first barrel 31. The first C-ring 35 is disposed in the first barrel 31, and engages an annular groove unit 317 in an inner surface of the first barrel 31 and an annular groove unit 337 in an outer surface of the positioning nut 33 for retaining the positioning nut 33 within the first barrel 31. The first enclosing component 36 is disposed at an end of the outer knuckle 216 opposite to the second knuckle 224. The first enclosing bolt 37 extends through the first enclosing component 36 and engages threadedly the positioning nut 33 so as to cover the end of the outer knuckle 216. Since the positioning nut 33 is retained within and positioned relative to the first barrel 31, and since the first barrel is secured to the second knuckle 224, the first end 322 of the torsion spring 32 is secured to the second knuckle 224.

The torque-adjusting unit 40 includes a cam mechanism 41 and a shaft 42.

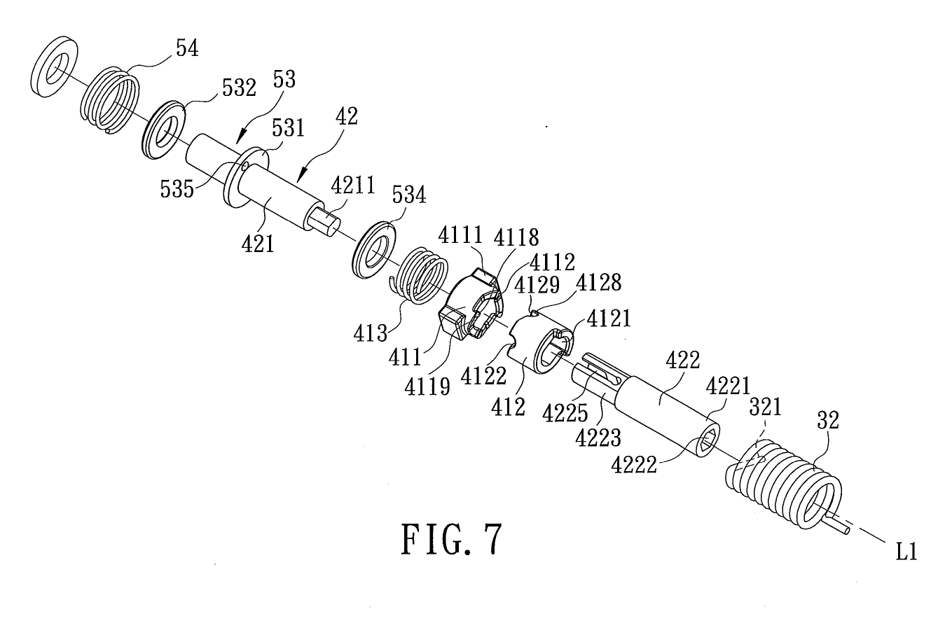

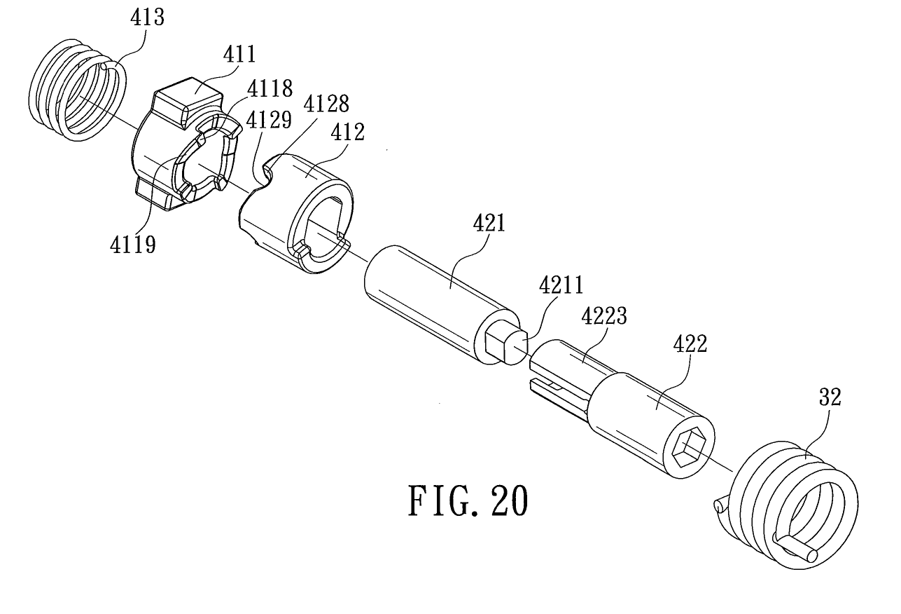

The cam mechanism 41 is disposed in the first knuckle 212, and includes a hollow cam 411, a hollow cam follower 412, and a resilient component 413. Referring further to FIGS. 7 and 20, the cam 411 is formed with a pair of engaging blocks 4111 that are angularly spaced apart from each other, that project radially and outwardly therefrom, and that engage the stepped surface portion 218 of the internal surface of the first knuckle 212 such that the cam 411 is coupled co-rotatably to and is axially movable relative to the first knuckle 212. The cam 411 is further formed with a plurality of angularly spaced-apart protrusions 4112 protruding in a direction parallel to the axis (L1) from an end thereof. Each of the protrusions 4112 has a steep slope face 4118 and a gentle slope face 4119 opposite to the steep slope face 4118. The cam follower 412 is disposed rotatably in the stepped surface portion 215 of the first knuckle 212, and has a central hole 4121 extending therethrough along the axis (L1), and a plurality of recesses 4122 formed at an end thereof adjacent to the cam 411 and engaging respectively and removably the protrusions 4112 of the cam 411. Each of the recesses 4122 is defined by a steep slope face 4128 and a gentle slope face 4129. The resilient component 413 is disposed for biasing resiliently the cam 411 toward the cam follower 412.

The shaft 42 extends along the axis (L1) in the channel unit 250, and includes first and second shaft segments 421, 422 coupled co-rotatably to each other. The first shaft segment 421 extends from the first knuckle 212 the outer knuckle 213 through the second knuckle 222, and has a non-circular insert end portion 4211. The second shaft segment 422 extends from the first knuckle 212 into the outer knuckle 216 through the second knuckle 224, and has a hollow coupling end portion 4223 extending fittingly through the central hole 4121 in the cam follower 412 so as to be coupled co-rotatably to the cam follower 412. The insert end portion 4211 of the first shaft segment 421 is inserted fittingly into the coupling end portion 422 of the second shaft segment 422 so as to be coupled co-rotatably to the second shaft segment 422 and the cam follower 412. The coupling end portion 4223 of the second shaft segment 4223 is formed with a slot 4225 for retaining the second end 321 of the torsion spring 32 of the torque-providing unit 30 therein, such that the cam follower 412 is coupled co-rotatably to the second end 321 of the torsion spring 32. The second shaft segment 4223 further has a driven end portion 4221 opposite to the coupling end portion 4223 and formed with an accessible hexagonal tool driven hole 4222 so that the shaft 42 is capable of being driven to rotate.

Referring once again to FIGS. 2 to 4, and further referring to FIG. 7, the friction-providing unit 50 includes a second barrel 51, a threaded limiting member 52, a friction-providing component 53, a resilient member 54, an adjusting component 55, a second C-ring 56, a second enclosing component 57, and a second enclosing bolt 58.

The second barrel 51 extends in the outer knuckle 213 and the second knuckle 222 of the hinge unit 20, and has an elliptical barrel body extending fittingly into the elliptical channel portion 223 in the second knuckle 222 so as to be coupled co-rotatably to the second knuckle 222. The barrel body of the second barrel 51 is formed with an internal flange 515 projecting radially and inwardly therefrom, and having a first side 5151 against which the resilient component 413 resiliently abuts, and a second side 5152 which is opposite to the first side 5151 along the axis (L1). The barrel body of the second barrel 51 is further formed with a threaded hole 511 registered with the first groove 214 in the outer knuckle 213.

In this embodiment, the friction-providing component 53 is disposed within the second barrel 51, is provided co-rotatably on the shaft 42, and includes a flange 531, a pair of first protrusions 533, a pair of second protrusions 535, and a pair of first and second brake plates 532, 534. The flange 531 projects radially and outwardly from the first shaft segment 421 of the shaft 42, and has opposite side surfaces. The first protrusions 553 protrude from one of the side surfaces of the flange 531, while the second protrusions 535 protrude from the other one of the side surfaces of the flange 531. The second brake plate 534 is disposed between the flange 531 and the second side 5152 of the internal flange 515 of the second barrel 51, and the first brake plate 532 is disposed at a side of the flange 531 opposite to the second brake plate 534 along the axis (L1).

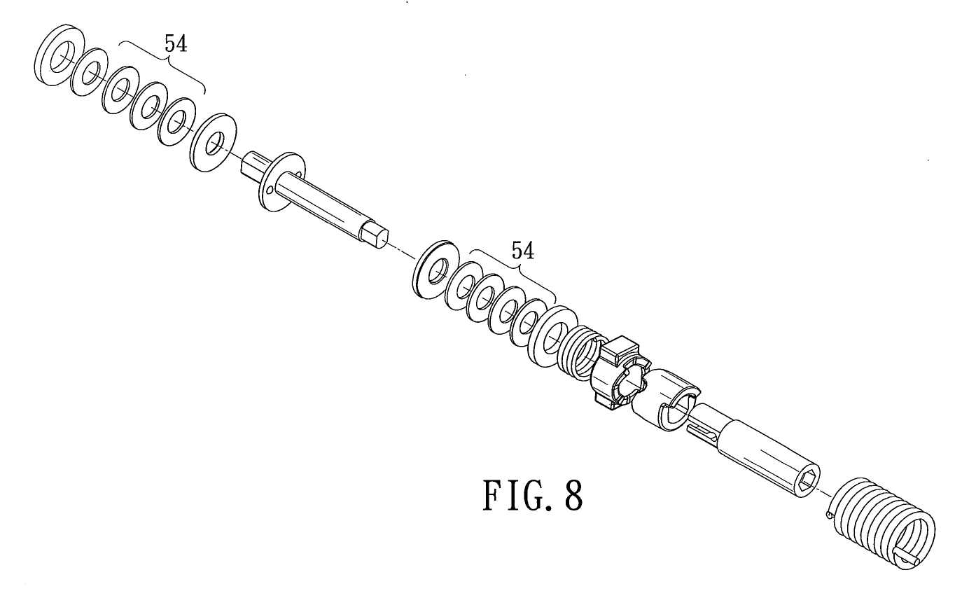

In this embodiment, the resilient member 54 is a compression spring made of a music wire, and is disposed at one side of the first brake plate 532 opposite to the internal flange 515 of the second barrel 51 along the axis (L1). Moreover, the actual form of the resilient member 54 is not limited. As illustrated in FIG. 8, a possible modified form of the resilient member 54 includes a plurality of disc springs.

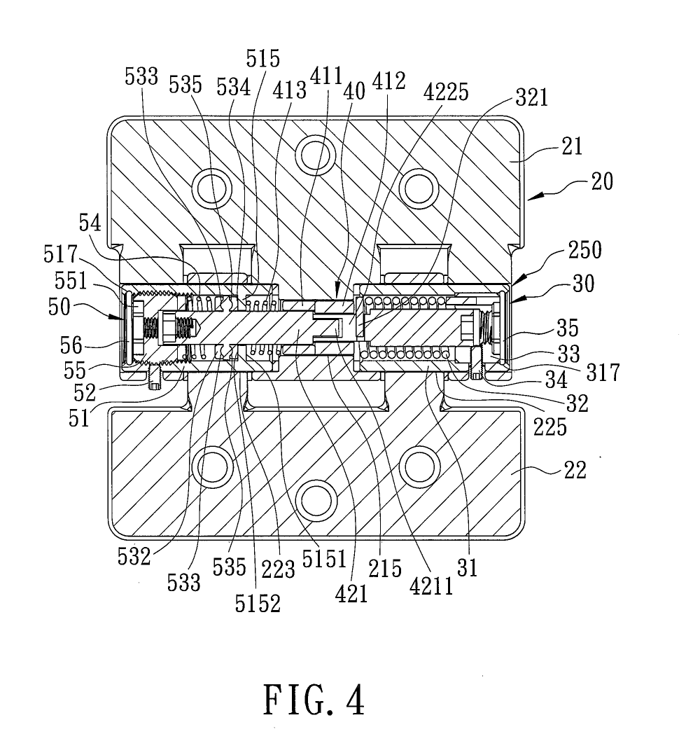

The adjusting component 55 is disposed in the second barrel 51, has an external thread engaging an internal thread in an inner surface of the second barrel 51, and has an end that abuts against the resilient member 54 and an opposite end that is formed with an accessible hexagonal driven hole 551 (see FIG. 4) so that the adjusting component 55 is capable of being driven to move toward and away from the friction-providing component 53 along the axis (L1). When the adjusting component 55 is moved toward the friction-providing component 53, it drives the resilient member 54 to abut resiliently against the first brake plate 532, such that the first and second brake plates 532, 534 are biased by the resilient member 54 to press against the first and second protrusions 533, 535 at the flange 531, thereby resulting in friction against the rotation of the shaft 42. In this embodiment, the first and second brake plates 532, 534 are made from a material softer than the first and second protrusions 533, 535, and are able to deform to abut fittingly against the first and second protrusions 533, 535, thereby resulting in a relatively large friction between the flange 531 and the first and second brake plates 532, 534.

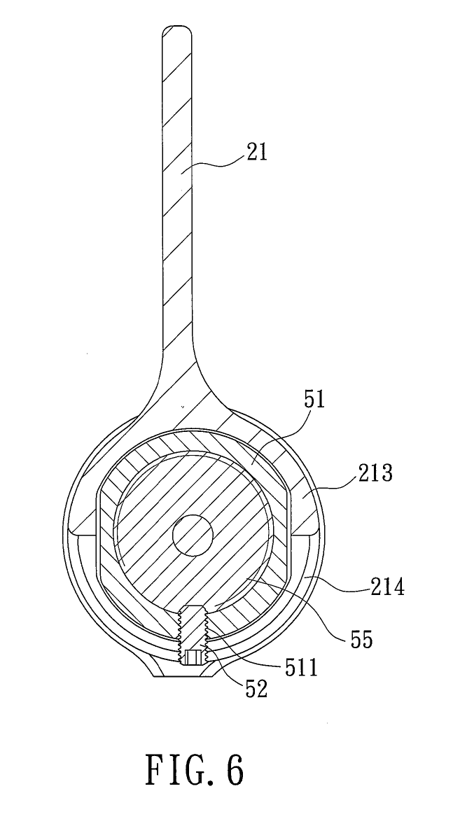

Referring further to FIG. 6, the threaded limiting member 52 extends threadedly through the threaded hole 511 in the barrel body of the second barrel 51 to press against the adjusting component 55 for locking the adjusting component 55 relative to the second barrel 51, and has one end opposite to the adjusting component 55 and extending outwardly of the second groove 214 in the outer knuckle 213 of the knuckle unit 280 of the hinge unit 20 via the threaded hole 511.

The second C-ring 56 is disposed in the second barrel 51, and engages an annular groove unit 517 in the inner surface of the second barrel 51 and an annular groove unit 557 in an outer surface of the adjusting component 55 for retaining the adjusting component 55 within the second barrel 51. The second enclosing component 57 is disposed at an end of the outer knuckle 213 opposite to the second knuckle 222, and extends into the second barrel 51. The second enclosing bolt 58 extends through the second enclosing component 57 and engages threadedly the adjusting component 55 so as to cover the end of the outer knuckle 213.

The assembling process of the first preferred embodiment of this invention will now be described in the following.

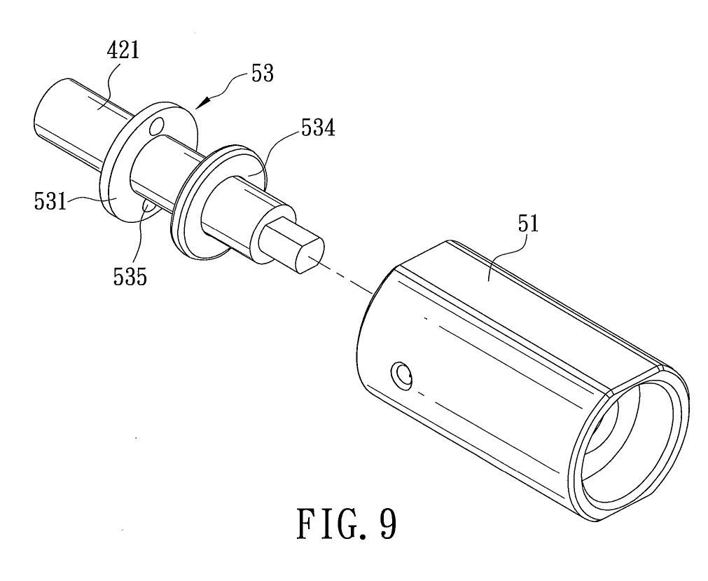

As shown in FIG. 9, the first step of the assembling process is to sleeve the second brake plate 534 of the friction-providing component 53 on the first shaft segment 421 of the shaft 42 to abut against the second protrusions 535 at the flange 531 of the friction-providing component 53, and to insert the first shaft segment 421 and the second brake plate 534 into the second barrel 51 via an end of the second barrel 51.

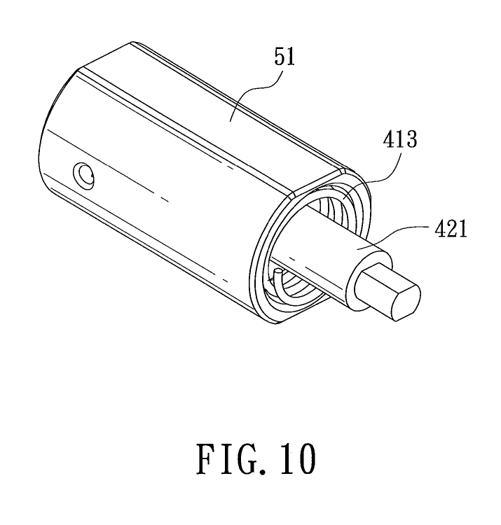

As shown in FIG. 10, the second step is to insert the resilient component 413 into the second barrel 51 via an opposite end of the second barrel 51 to sleeve on the first shaft segment 421.

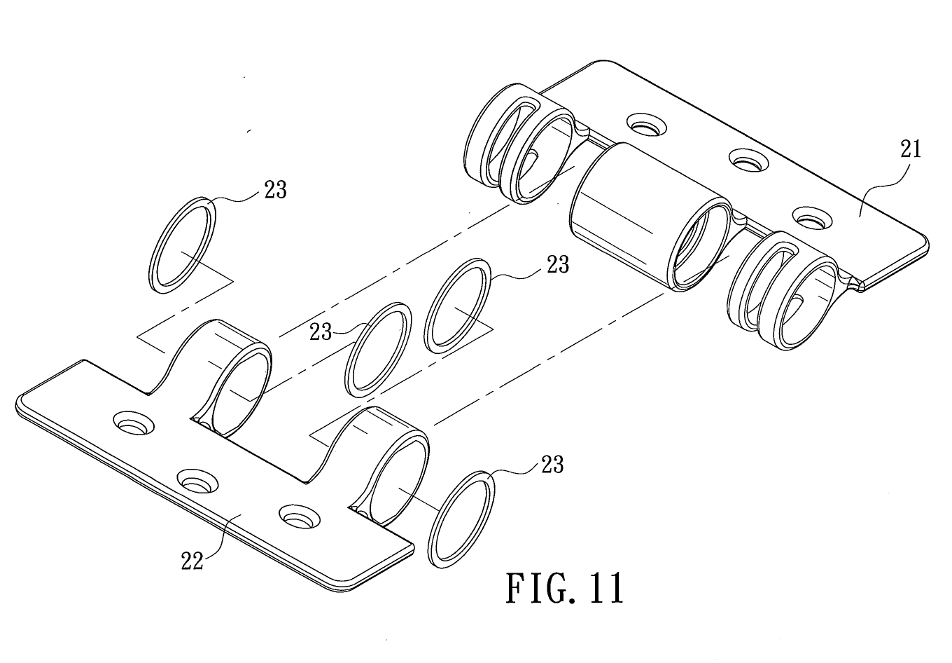

Referring to FIG. 11, the third step is to couple the first leaf 21 to the second leaf 22, and to dispose the spacer components 23 between the first and second leaves 21, 22.

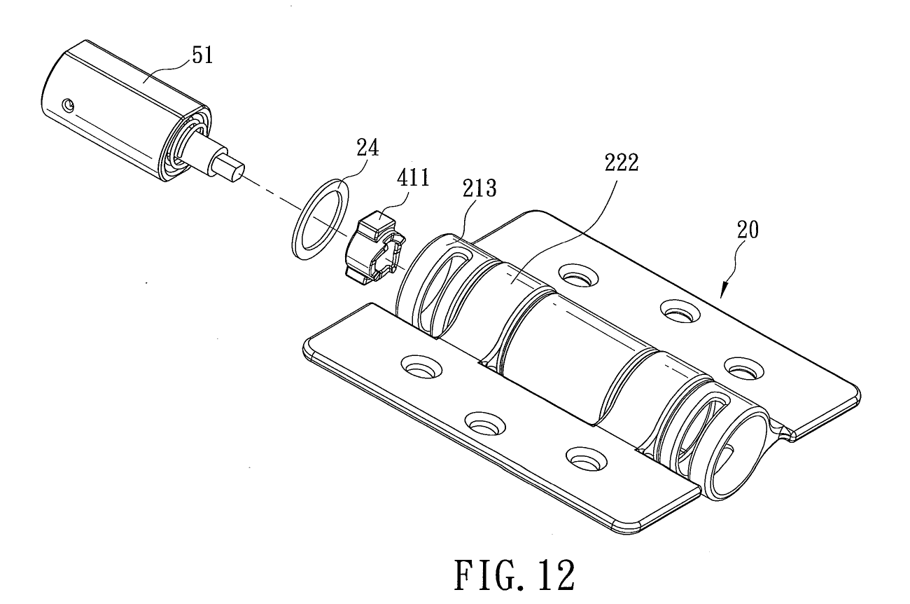

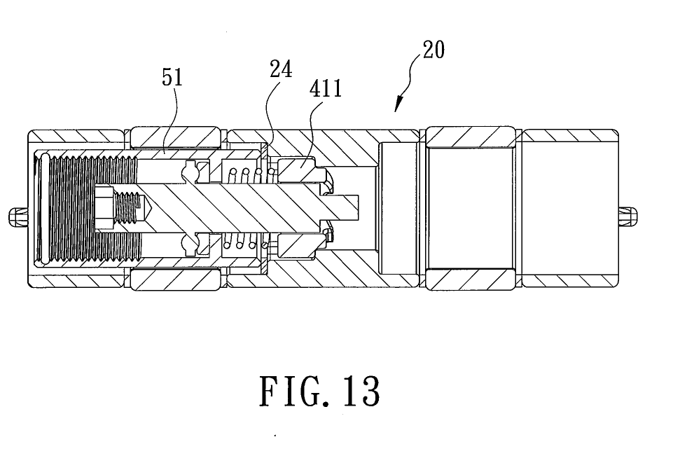

Referring to FIGS. 12 and 13, the fourth step is to insert the cam 411, a washer 24, and the assembly of the second barrel 51, the first shaft segment 421, the second brake plate 534, and the resilient component 413 into the outer knuckle 213 and the second knuckle 222 of the hinge unit 20.

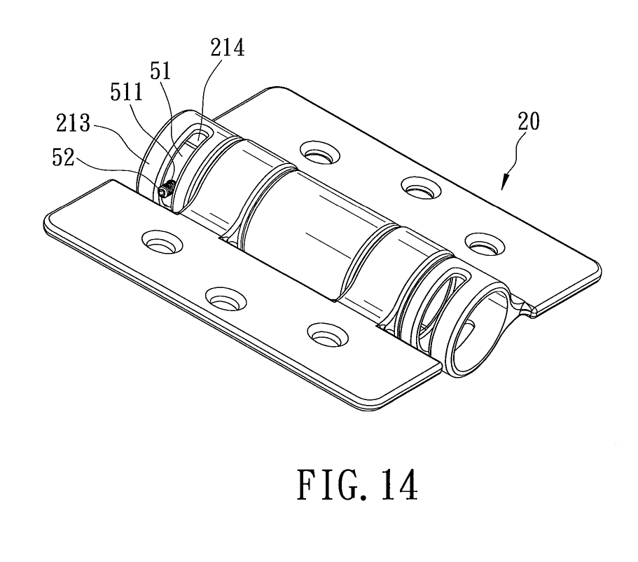

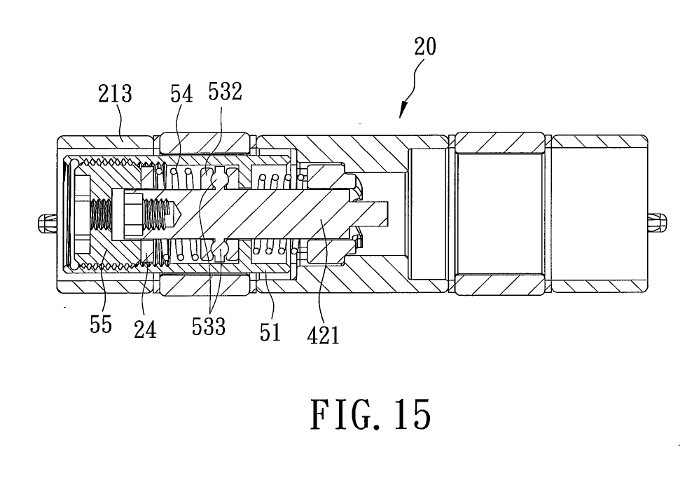

As shown in FIGS. 14 and 15, the fifth step is to sleeve the first brake plate 532 on the first shaft segment 421 of the shaft 42 to abut against the first protrusions 533, to insert the resilient member 54 and another washer 24 into the second barrel 51 in such a manner to sleeve the same on the first shaft segment 421, and to insert the adjusting component 55 threadedly into the second barrel 51, and to extend threadedly the threaded limiting member 52 into the threaded hole 511 in the second barrel 51 via the second groove 214 in the outer knuckle 213, thereby locking the adjusting component 55 relative to the second barrel 51.

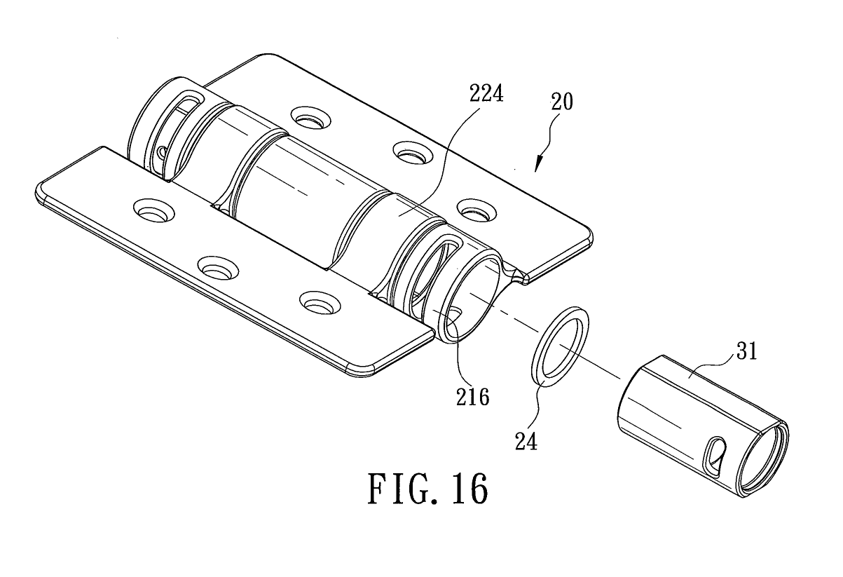

Referring to FIG. 16, the sixth step is to insert the first barrel 31 and another washer 24 into the outer knuckle 216 and the second knuckle 224 of the knuckle unit 20.

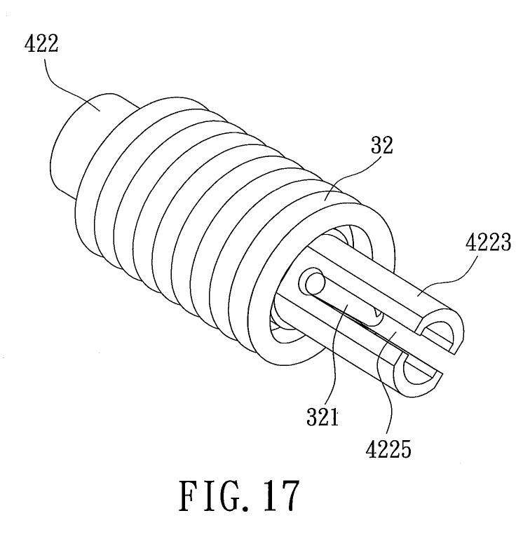

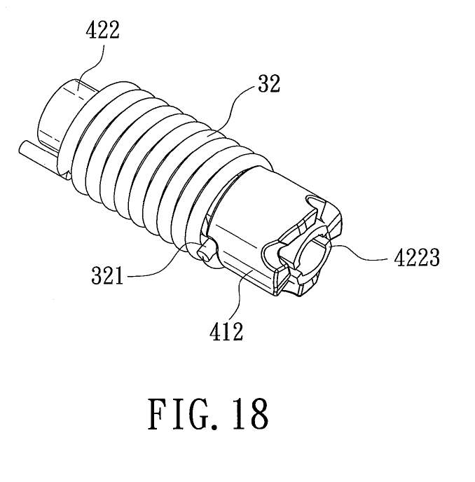

As shown in FIGS. 17 and 18, the seventh step is to sleeve the torsion spring 32 on the second shaft segment 422, to insert the second end 321 of the torsion spring 32 into the slot 4225 in the coupling end portion 4223 of the second shaft segment 422, and to sleeve the cam follower 412 on the coupling end portion 4223 of the second shaft segment 422 for securing the second end 321 of the torsion spring 32 to the second shaft segment 422.

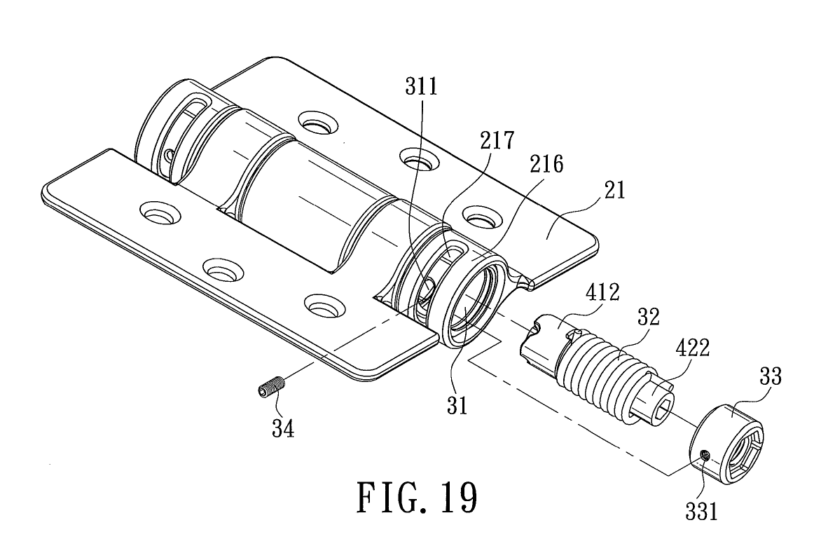

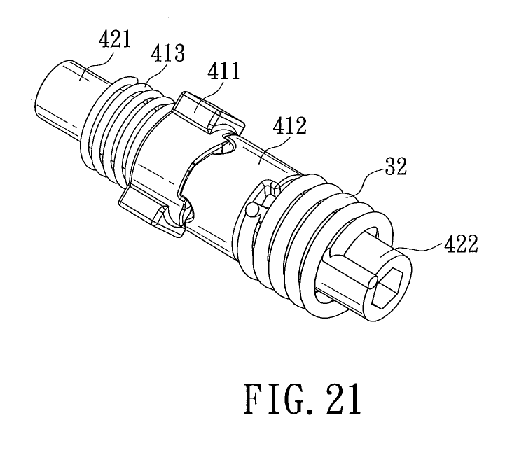

Referring to FIG. 19, the eighth step is to insert the assembly of the second shaft segment 422, the torsion spring 32, and the cam follower 412 into the first barrel 31, to insert the positioning nut 33 into the first barrel 31, and to extend threadedly the threaded limiting component 34 into the positioning hole 331 in the positioning nut 33 via the first groove 217 in the outer knuckle 216 and the through hole 311 in the first barrel 31, thereby positioning the positioning nut 33 relative to the first barrel 31. Consequently, the second shaft segment 422 is coupled to the first shaft segment 421 via the engagement between the coupling end portion 4223 of the second shaft segment 422 and the insert end portion 4211 of the first shaft segment 421, and the cam 411 is biased resiliently by the resilient component 413 to be coupled to the cam follower 412 (see FIGS. 20 and 21).

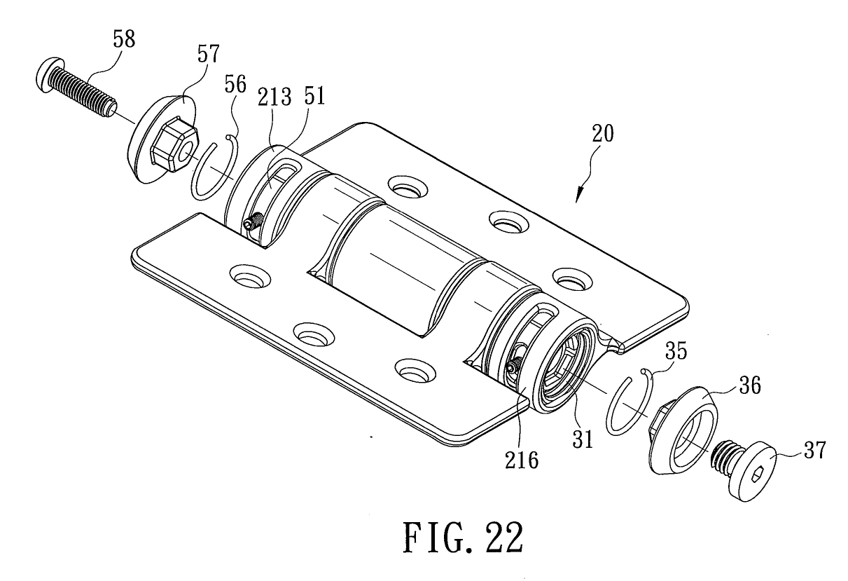

Referring to FIG. 22, the ninth step is to couple the first C-ring 35, the first enclosing component 36 and the first enclosing bolt 37 to the first barrel 31, and to couple the second C-ring 56, the second enclosing component 57 and the second enclosing bolt 58 to the second barrel 51 for completing the assembling process.

In use, during the door-opening process, the first leaf 21 is pivoted relative to the second leaf 22, while the first knuckle 212 and the outer knuckles 213, 316 are rotated in a first rotational direction (R1) (see FIG. 2) relative to the second knuckles 222, 224. Simultaneously, the cam 411 of the cam mechanism 41 of the torque-adjusting unit 4 is driven to rotate in the first rotational direction (R1), and engages the cam follower 412 with the protrusions 4112 of the cam 411 engaging respectively the recesses 4122 in the cam follower 412 through abutment of the steep slope face 4118 of each of the protrusions 4112 of the cam 411 against the steep slope face 4128 defining a respective one of the recesses 4122, such that the cam follower 412 is driven to rotate in the first rotational direction (R1) together with the cam 411. Since the second end 321 of the torsion spring 32 of the torque-providing unit 30 is coupled co-rotatably to the shaft 42 of the torque-adjusting unit 40 and the cam follower 412, and since the first end 322 of the torsion spring 32 is secured to the second knuckle 224, the rotation of the cam follower 412 twists the torsion spring 32.

When a force for opening the door is released, the cam follower 412 is driven by a restoring force of the torsion spring 32 to automatically rotate in a second rotational direction (R2) (see FIG. 2) opposite to the first rotational direction (R1) so as to drive the cam 411 to rotate in the second rotational direction (R2) through abutment of the steep slope face 4128 of each of the recesses 4122 against the steep slope face 4118 of a respective one of the protrusions 4112 of the cam 411, thereby driving the first knuckle 212 to rotate in the second rotational direction (R2) relative to the second knuckles 222, 224, and eventually driving the first leaf 21 to pivot reversely relative to the second leaf 22 to complete a door-closing process.

Moreover, before the door is opened, by disengaging the first enclosing bolt 37 from the positioning nut 33 and removing the first enclosing component 36 from the first barrel 31, a user is able to insert a hand tool (such as a hex wrench) into the tool driven hole 4221 in the second shaft segment 422 of the shaft 42 and operate the hand tool to rotate the shaft 42 in the first rotational direction (R1), thereby twisting the torsion spring 32 so as to increase the torque of the torsion spring 32. At the same time, the cam follower 412 is also driven to rotate in the first rotational direction (R1) relative to the cam 411, thereby biasing the cam 411 to move away from the cam follower 412 along the axis (L1) against a resilient force of the resilient component 413 through sliding movement of each of the gentle slope faces 4129 of the cam follower 412 relative to the gentle slope face 4119 of the respective one of the protrusions 4112 of the cam 411. After the torque adjustment, the hand tool is removed from the tool driven hole 4221, so that a restoring force of the resilient component 413 biases the cam 411 to press against the cam follower 412, thereby preventing the cam follower 412 from being rotated in the second rotational direction (R2) by a restoring force of the torsion spring 32. Therefore, the adjusted torque of the torsion spring 32 can be maintained.

Furthermore, before the door is opened, by disengaging the second enclosing bolt 58 from the adjusting component 55 and removing the second enclosing component 57 from the second barrel 51, the user is able to insert the hand tool into the driven hole 551 in the adjusting component 55 and operate the hand tool to drive the adjusting component 55 to move threadably toward the friction-providing component 53 of the friction-providing unit 50 along the axis (L1), thereby increasing the resilient force of the resilient member 54 that is exerted to the first and second brake plates 532, 534, such that the friction between the first brake plate 532 and the first protrusions 533 on the flange 531 as well as the friction between the second brake plate 534 and the second protrusions 535 on the flange 531 is increased so as to slow down the rotation of the shaft 42 and the cam follower 412 in the second rotational direction (R2) due to the untwisting action of the torsion spring 32. As such, the rotation of the cam 411 and the first knuckle 212 in the second rotational direction (R2) is slowed down, so that the pivoting movement of the first leaf 21 relative to the second leaf 22 during the door-closing process is also slowed down to prevent the door panel from severely striking the door frame. On the contrary, the adjusting component 55 can also be rotated in the same manner to move threadably away from the friction-providing component 53 along the axis (L1), thereby decreasing the friction between the first brake plate 532 and the first protrusions 533 as well as the friction between the second brake plate 534 and the second protrusions 535 so as to speed up the rotation of the shaft 42 and the cam follower 412 in the second rotational direction (R2), and to eventually speed up the pivoting movement of the first leaf 21 relative to the second leaf 22 during the door-closing process.

From the aforementioned description, the advantages of the hinge device according to the present invention can be summarized as follows:

1. By virtue of the untwisting action of the torsion spring 32, the first leaf 21 can be automatically driven to pivot relative to the second leaf 22 to result in the door-closing process.

2. By operating the torque-adjusting unit 40 to rotate the shaft 42 in the first rotational direction (R1), the torque of the torsion spring 32 of the torque-providing unit 30 can be easily adjusted. Moreover, the shaft 42 can be rotated freely for 360 degrees during the torque adjustment so as to twist or untwist the torsion spring 32.

3. By operating the friction-providing unit 50, the speed of the pivoting movement of the first leaf 21 relative to the second leaf 22 can be properly adjusted.

4. By virtue of the spacer components 23, the first leaf 21 can be pivoted smoothly relative to the second leaf 22.

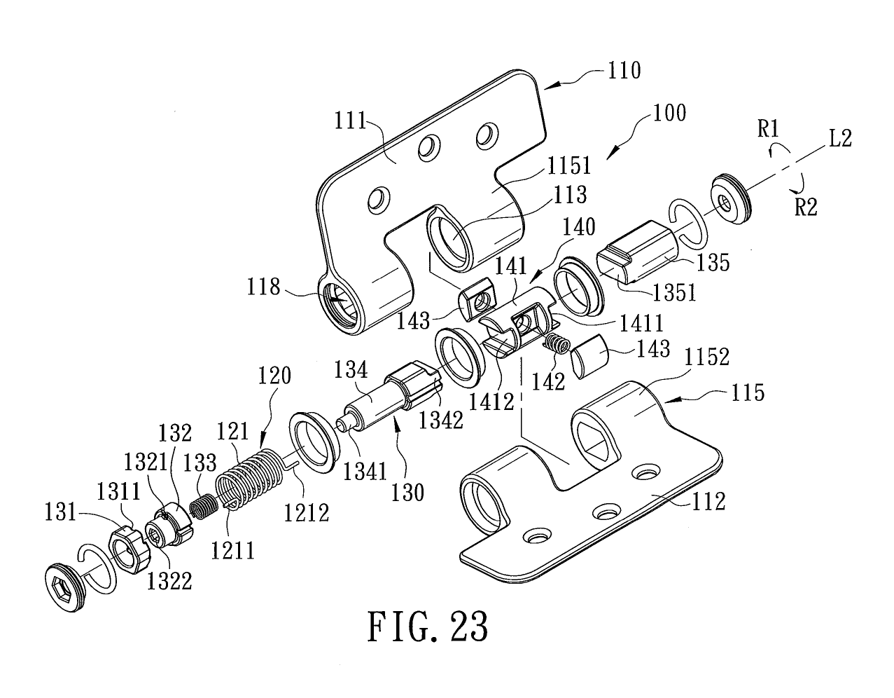

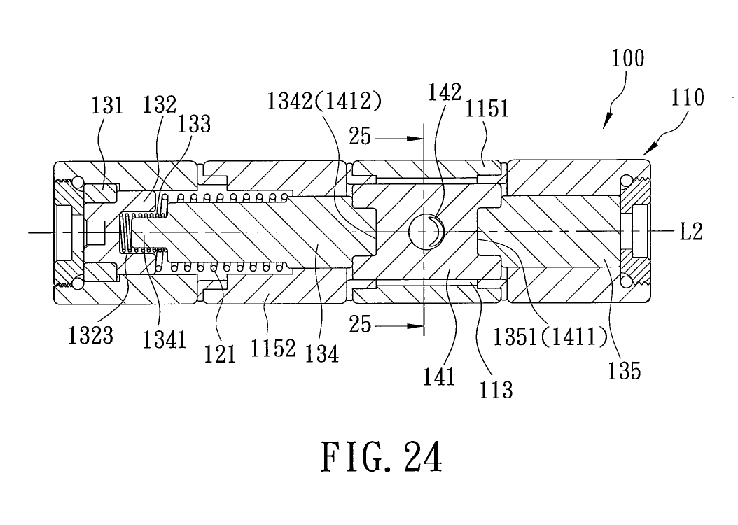

As shown in FIGS. 23 to 25, the second preferred embodiment of the hinge device 100 according to the present invention has a structure similar to that of the first preferred embodiment. The main difference between this embodiment and the previous embodiment resides in the following. The hinge device 100 includes a hinge unit 110, a torque-providing unit 120, a torque-adjusting unit 130, and a friction-providing unit 140.

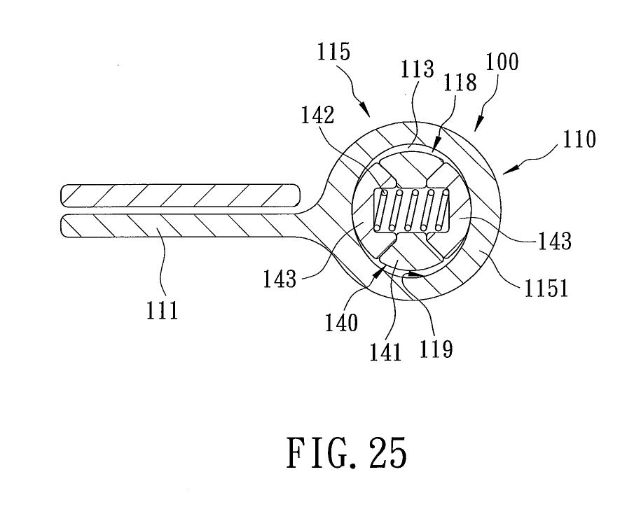

The hinge unit 110 includes a first leaf 111 adapted to be mounted to a door panel (not shown), a second leaf 112 adapted to be mounted to a door frame (not shown), and a knuckle unit 115. The knuckle unit 115 includes a pair of first knuckles 1151 provided to the first leaf 111, and a pair of second knuckles 1152 provided to the second leaf 112 and coupled to the first knuckles 1151 such that the first leaf 111 is pivotable relative to the second leaf 112. The knuckle unit 115 has an inner surrounding surface unit 119 (see FIG. 25) defining a channel unit 118 therein. In this embodiment, a portion of the channel unit 118 that is within the right first knuckle 1151 is an elliptical channel portion 113. The torque-providing unit 120 includes a torsion spring 121 that has opposite first and second ends 1211, 1212. The torque-adjusting unit 130 includes a hollow cam 131, a cam follower 132, a resilient component 133, and a shaft 134. The cam 131 is coupled co-rotatably to the left first knuckle 1151 and is formed with a plurality of recesses 1311. The cam follower 132 is rotatable relative to the first knuckles 1151 and is secured to the first end 1211 of the torsion spring 121. The cam follower 132 has a first end portion extending rotatably into the cam 131, and is formed with an accessible hexagonal hole 1322 and a plurality of protrusions 1321 for engaging respectively and removably the recesses 1311 in the cam 131. The cam follower 132 further has a second end portion opposite to the first end portion along an axis (L2) and is formed with a receiving hole 1323. The resilient component 133 is disposed within the receiving hole 1323. The shaft 134 is secured to the second end 1212 of the torsion spring 121, and has a cylindrical end 1341 which extends movably into the receiving hole 1323 and on which the resilient component 133 is sleeved, such that the cam follower 132 is biased resiliently by the resilient component 133 toward the cam 131. The shaft 134 further has a coupling end 1342 opposite to the cylindrical end 1341 and formed with a flat engaging block.

The friction-providing unit 140 includes a rod member 141 that extends along the axis (L2) in the portion of the channel unit 118 (i.e., the elliptical channel portion 113), a pair of friction-providing blocks 143 that are disposed movably and respectively at diametrically opposite sides of the rod member 141, and a block-engaging spring 142 that extends transversely through the rod member 141 and that has opposite ends connected respectively to the friction-providing blocks 143 for biasing resiliently and outwardly the friction-providing blocks 143 to move into frictional contact with the inner surrounding surface unit 119 of the knuckle unit 115. The rod member 141 has opposite ends along the axis (L2) formed respectively with a pair of engaging slots 1411, 1412. The friction-providing unit 140 further includes a coupling block 135 secured to one of the second knuckles 1152 of the knuckle unit 115, and having an engaging end 1351 formed with a flat engaging block. The engaging block of the coupling end 1342 of the shaft 134 is inserted fittingly into the engaging slot 1412 in the rod member 141 for coupling the shaft 134 to the rod member 141. The engaging block of the engaging end 1351 of the coupling block 135 is inserted fittingly into the engaging slot 1411 in the rod member 141 for coupling the rod member 141 to the coupling block 135.

During the door-opening process, the first knuckles 1151 are rotated in the first rotational direction (R1) relative to the second knuckles 1152, and the cam 131 is rotated together with the first knuckles 1151 so as to drive the cam follower 132 to rotate together therewith through engagement between the protrusions 1321 of the cam follower 132 and the recesses 1311 in the cam 131.

Meanwhile, the assembly of the shaft 134 and the friction-providing unit 140 is not rotated since the coupling block 135 is secured to the one of the second knuckles 1152. Since the first end 1211 of the torsion spring 121 is secured to the cam follower 132 while the second end 1212 of the torsion spring 121 is secured to the shaft 134, the torsion spring 121 is twisted during the door-opening process.

Before the door-opening process, by inserting a hand tool into the hexagonal hole 1322 in the cam follower 132, the cam follower 132 is accessibly operable to rotate in the first rotational direction (R1) so as to twist the torsion spring 121, thereby increasing the torque of the torsion spring 121. Moreover, the cam follower 132 is further accessibly operable to separate from the cam 131 along the axis (L2) so as to untwist the torsion spring 121, thereby allowing readjustment of the torque of the torsion spring 121. The resilient component 133 is compressed when the cam follower 132 is separated from the cam 131. The cam follower 132 is biased by a restoring force of the resilient component 133 to move back to re-engage the cam 131 after the torque adjustment.

During the pivoting movement of the first leaf 111 relative to the second leaf 112, one of the first knuckles 1151 defining the elliptical channel portion 113 is rotated relative to the rod member 141, so as to vary angular orientation of the rod member 141 relative to the elliptical channel portion 113 and, thus, the biasing force of the block-engaging spring 142 for biasing the friction-providing blocks 143 into frictional contact with the inner surrounding surface unit 119, thereby automatically changing the speed of the pivoting movement of the first leaf 111. The second preferred embodiment has the same advantages as those of the first preferred embodiment.

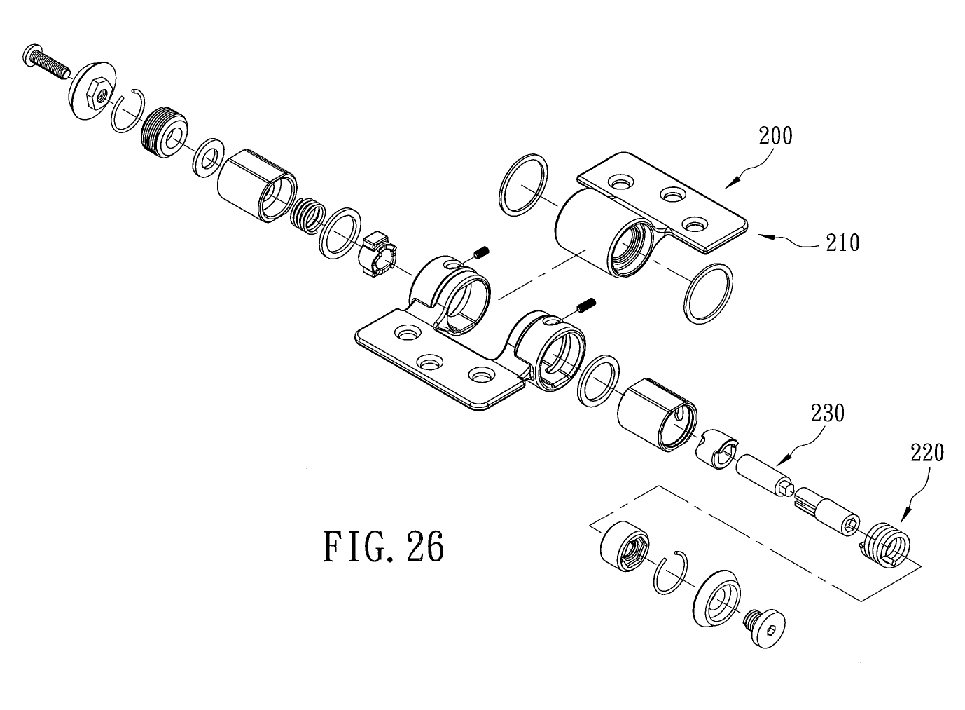

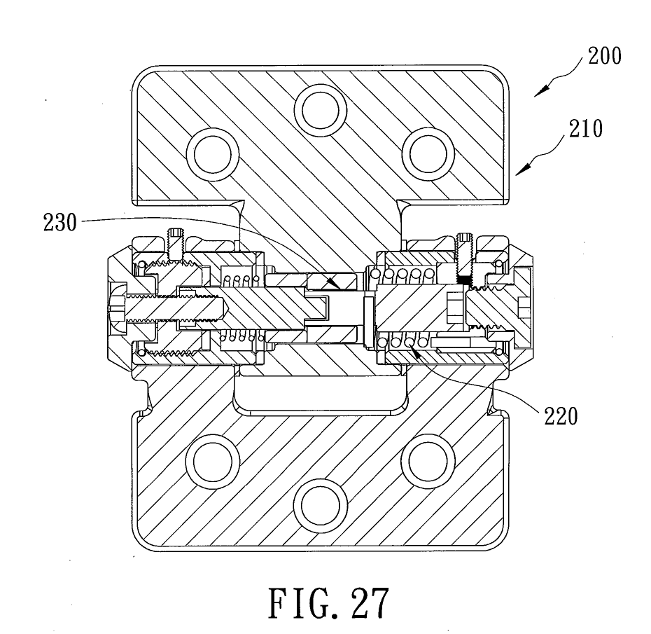

As shown in FIGS. 26 and 27, the third preferred embodiment of the hinge device 200 according to the present invention has a structure similar to that of the first preferred embodiment. In this embodiment, the hinge device 200 comprises a hinge unit 210, a torque-providing unit 220, and a torque-adjusting unit 230. The main difference between this embodiment and the first preferred embodiment resides in that the friction-providing unit 50 of the first preferred embodiment is omitted in this embodiment.

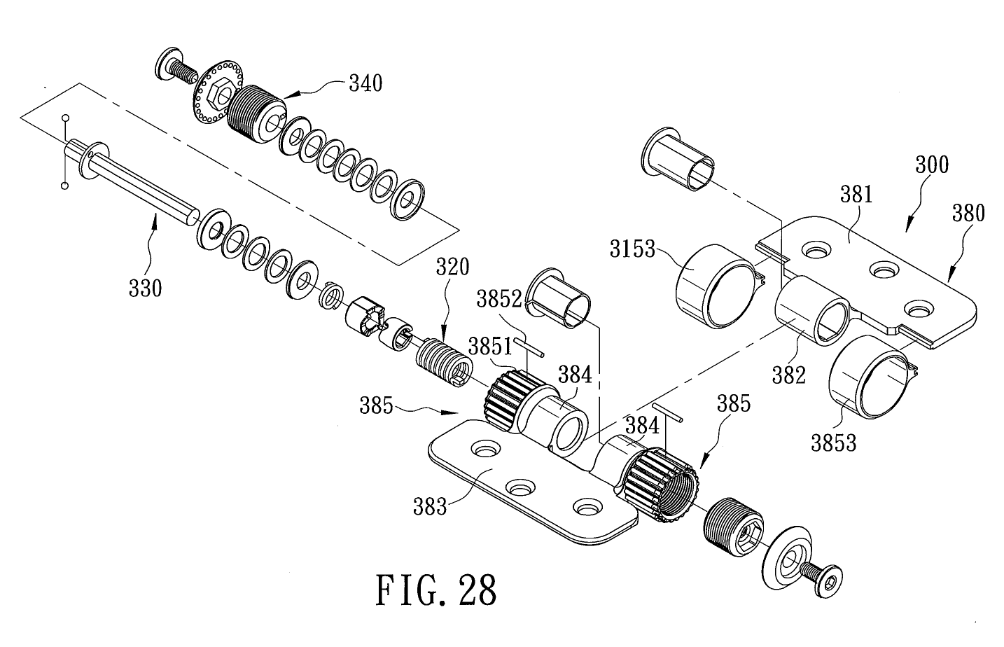

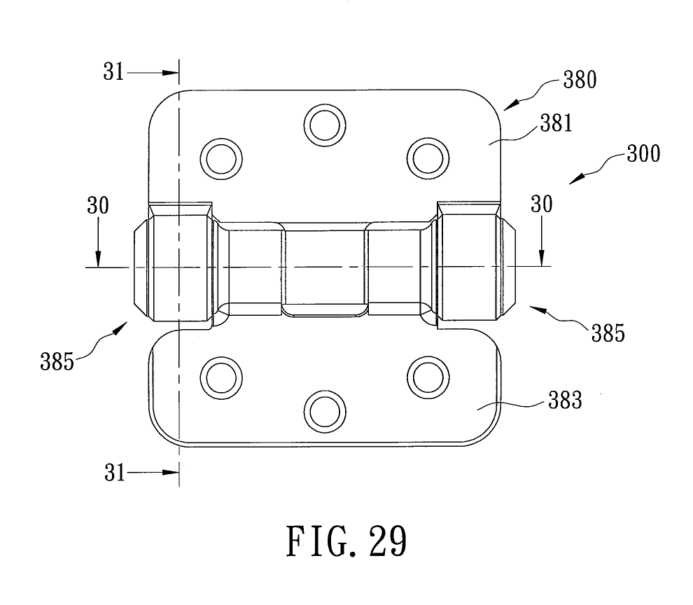

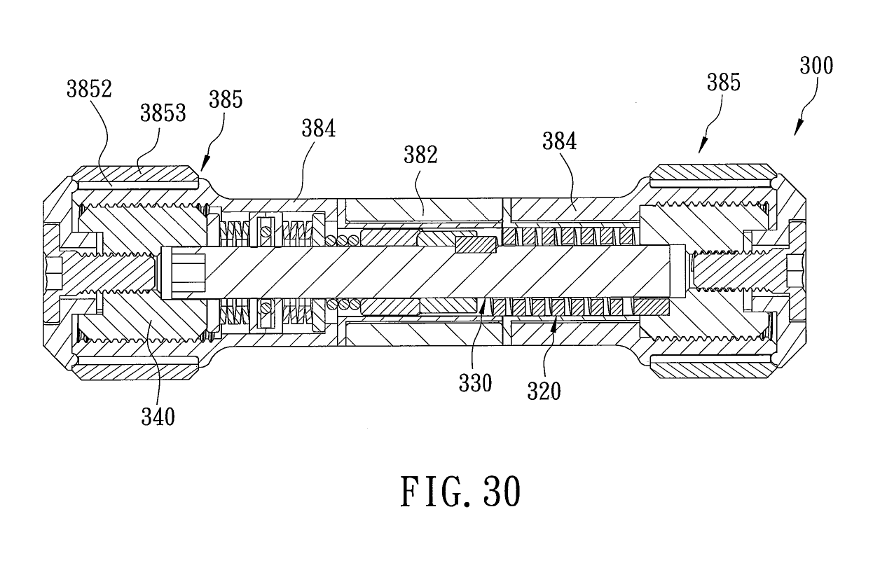

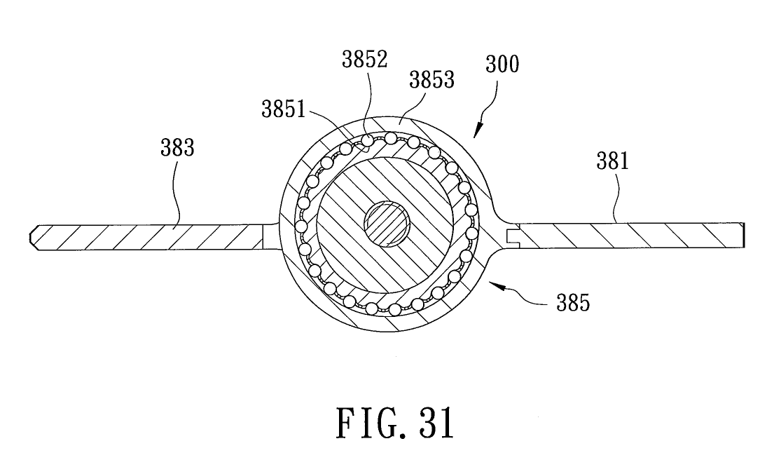

As shown in FIGS. 28 to 31, the fourth preferred embodiment of the hinge device 300 according to the present invention has a structure similar to that of the first preferred embodiment. In this embodiment, the hinge device 300 comprises a hinge unit 380, a torque-providing unit 320, a torque-adjusting unit 330, and a friction-providing unit 340. The main difference between this embodiment and the first preferred embodiment resides in the following. The hinge unit 380 includes a first leaf 381, a second leaf 383, a first knuckle 382 connected to a middle portion of a side of the first leaf 381, and a pair of second knuckles 384 connected to a side of the second leaf 383 and coupled respectively and pivotally to opposite ends of the first knuckle 382. The hinge unit 380 further includes a pair of bearing units 385 disposed between the first and second leaves 381, 382. In this embodiment, each of the bearing units 385 has a plurality of roller grooves 3851 formed in an outer surrounding surface of a respective one of the second knuckles 384, a plurality of rollers 3852 retained rotatably and respectively in the roller grooves 3851, and a barrel member 3853 sleeved rotatably on the rollers 3852 and welded to the first leaf 381. The fourth preferred embodiment has the same advantages as those of the first preferred embodiment.

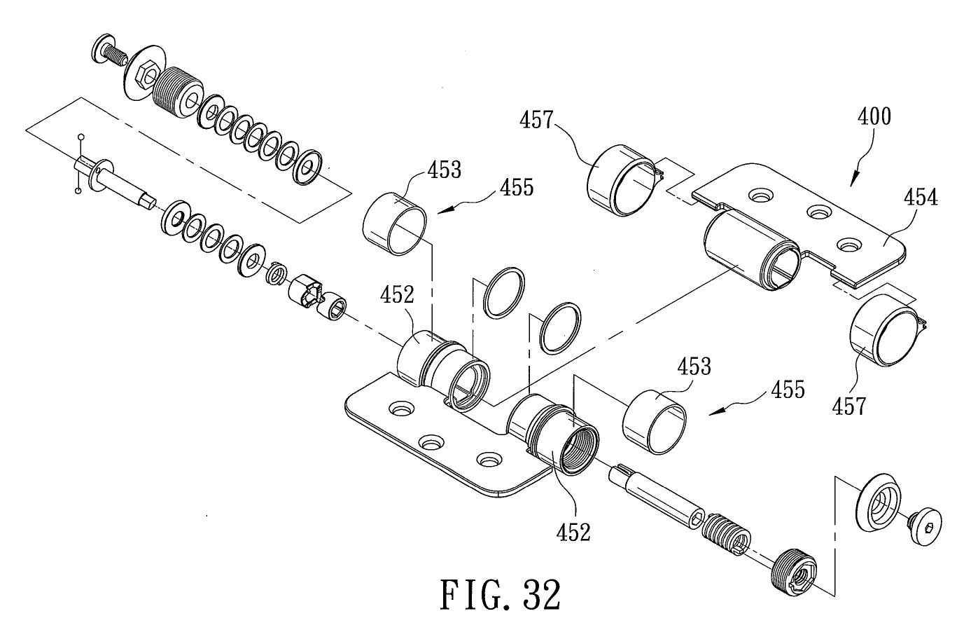

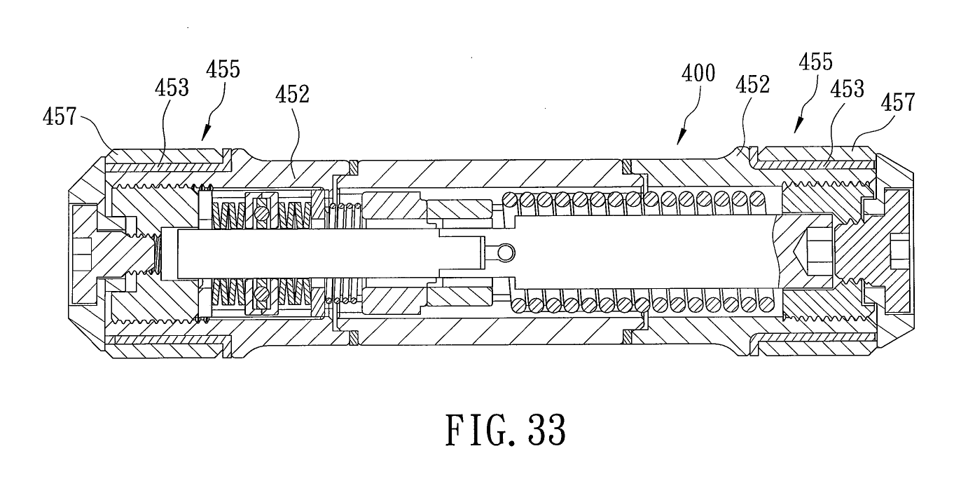

As shown in FIGS. 32 and 33, the fifth preferred embodiment of the hinge device 400 according to the present invention has a structure similar to that of the fourth preferred embodiment. The main difference between this embodiment and the fourth preferred embodiment resides in the configuration of the bearing unit. In this embodiment, each of the bearing units 455 includes a wear-resisting copper ring 453 sleeved on a respective one of the second knuckles 452, and a barrel member 457 sleeved rotatably on the wear-resisting copper ring 453 and welded to the first leaf 454.

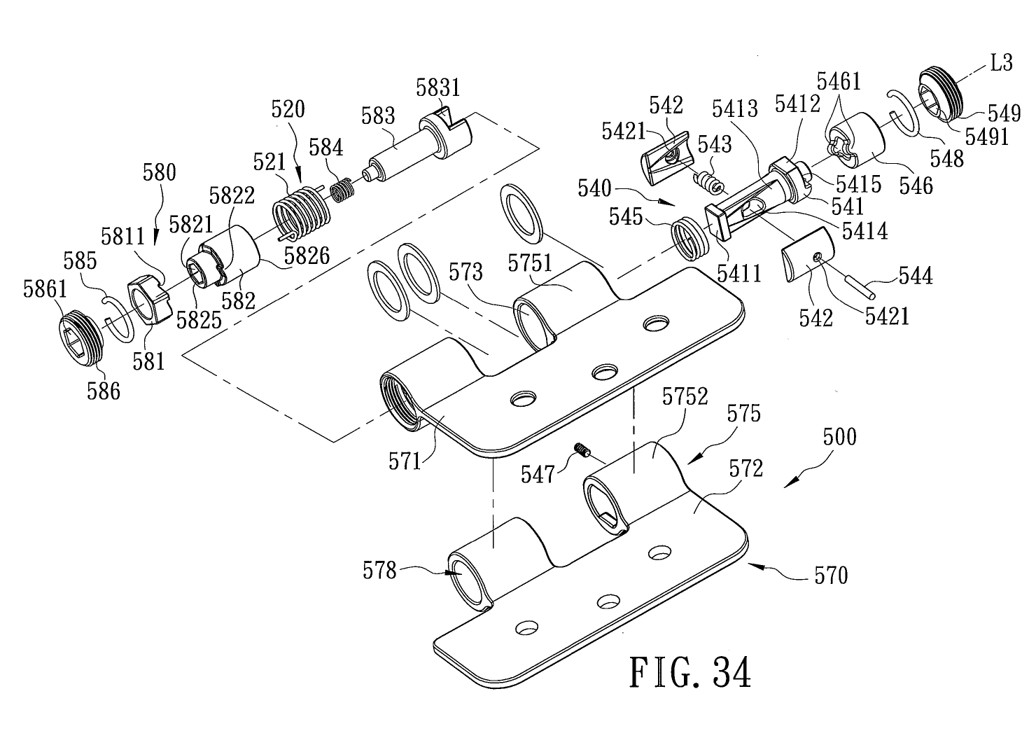

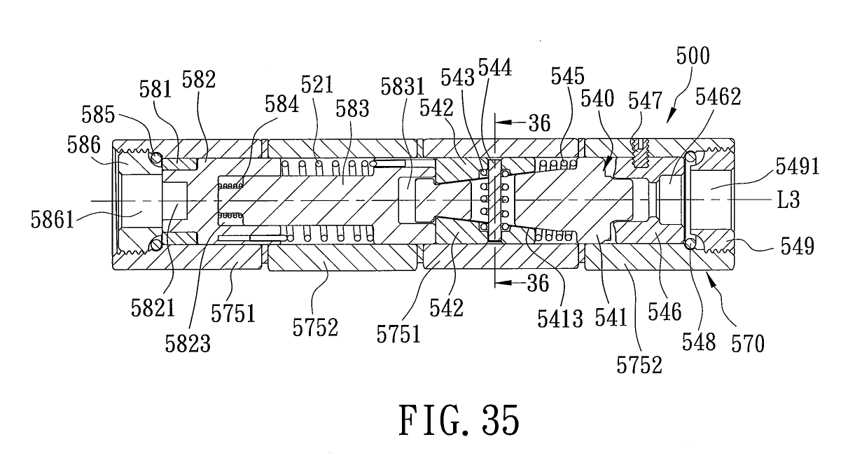

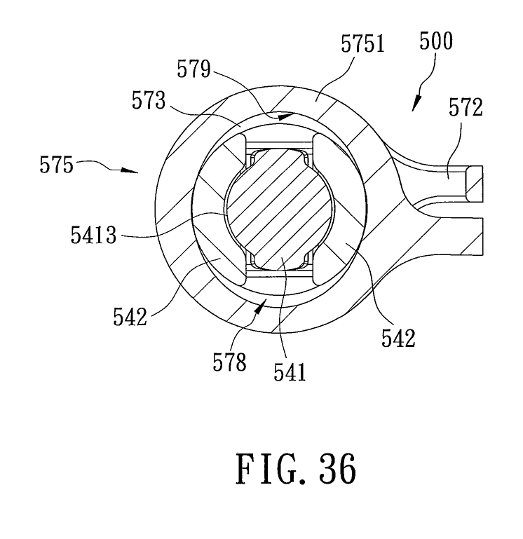

Referring to FIGS. 34 to 36, the sixth preferred embodiment of the hinge device 500 according to the present invention has a structure similar to that of the second preferred embodiment. In this embodiment, the hinge device 500 comprises a hinge unit 570, a torque-providing unit 520, a torque-adjusting unit 530 and a friction-providing unit 540.

The hinge unit 570 includes first and second leaves 571, 572, and a knuckle unit 575. The knuckle unit 575 includes a pair of first knuckles 5751 provided to the first leaf 571, and a pair of second knuckles 5752 provided to the second leaf 572 and coupled to the first knuckles 5751 such that the first leaf 571 is pivotable relative to the second leaf 572. The knuckle unit 575 has an inner surrounding surface unit 579 defining a channel unit 578 therein. In this embodiment, a portion of the channel unit 578 that is within the right first knuckle 5751 is an elliptical channel portion 573.

The torque-adjusting unit 580 includes a hollow cam 581, a cam follower 582, a resilient component 584, a shaft 583, a first C-ring 585, and a first enclosing bolt 586. The cam 581 is coupled co-rotatably the left first knuckle 5751 and is formed with a plurality of recesses 5811. The cam follower 582 is rotatable relative to the first knuckles 5751. The cam follower 582 has a left end portion 5825 extending rotatably into the cam 581, is formed with an accessible hexagonal hole 5821 and a plurality of protrusions 5822 for engaging respectively and removably the recesses 5811 in the cam 581. The cam follower 582 further has a right end portion 5826 opposite to the left end portion 5825 along an axis (L3) and formed with a receiving hole 5823. The resilient component 584 is disposed within the receiving hole 5823. The shaft 583 has a cylindrical end which extends movably into the receiving hole 5823 and on which the resilient component 584 is sleeved, such that the cam follower 582 is biased resiliently by the resilient component 584 toward the cam 581. The shaft 583 further has a coupling end opposite to the cylindrical end along the axis (L3) and formed with an engaging groove 5831. The first C-ring 585 and the first enclosing bolt 586 are disposed within the channel unit 578 for retaining the cam 581 within the channel unit 578. The first enclosing bolt 586 is formed with an internal hexagonal hole 5861 extending therethrough along the axis (L3). The torque-providing unit 520 includes a torsion spring 521 having opposite ends secured respectively to the cam follower 582 and the shaft 583.

The friction-providing unit 540 includes a rod member 541, a pair of friction-providing blocks 542, a coupling pin 544, a block-engaging spring 543, a cam component 546, a resilient component 545, a threaded locking component 547, a second C-ring 548, and a second enclosing bolt 549.

The rod member 541 extends along the axis (L3) in the portion of the channel unit 578 (i.e., the elliptical channel portion 573), and has a first longitudinal end 5411 formed with a rectangular block that engages the engaging groove 5831 in the shaft 583, and a second longitudinal end 5412 opposite to the first engaging end 5411 along the axis (L3), secured to one of the second knuckles 5752, and formed with a pair of cam surfaces 5415 (only one is shown). The rod member 541 further has a pair of inclined outer surfaces 5413 formed respectively at diametrically opposite sides thereof between the first and second longitudinal ends 5411, 5412, and an elongated through hole 5414 extending transversely through the inclined outer surfaces 5413. The friction-providing blocks 542 are disposed movably and respectively at diametrically opposite sides of the rod member 541, and are disposed respectively adjacent to the inclined outer surfaces 5413. Each of the friction-providing blocks 542 is formed with a pin hole 5421 extending transversely therethrough. The coupling pin 544 extends from the pin hole 5421 in one of the friction-providing blocks 542 into the pin hole 5421 in the other one of the friction-providing blocks 542 via the elongated through hole 5414 in the rod member 541. The block-engaging spring 543 is sleeved on the coupling pin 544, and extends through the elongated through hole 5414 in the rod member 541 with opposite ends inserted respectively into the pin holes 5421 in the friction-providing blocks 542 for biasing resiliently and outwardly the friction-providing blocks 542 to move into frictional contact with the inner surrounding surface unit 579 of the knuckle unit 575. The elongated through hole 5414 in the rod member 541 has a width larger than that of the block-engaging spring 543 such that the rod member 541 is axially movable relative to the friction-providing blocks 542. The cam component 546 is disposed in one of the second knuckles 5752 secured to the rod member 541, and has a pair of protrusions 5461 abutting rotatably and respectively against the cam surfaces 5415 of the rod member 541, and a hexagonal driven hole 5462 extending therethrough. The resilient component 545 is sleeved on the rod member 541 for biasing the rod member 541 to abut against the cam component 546. The second C-ring 548 and the second enclosing bolt 549 are disposed within the channel unit 578 for retaining the cam component 546 within the channel unit 578. The second enclosing bolt 549 is formed with an internal hexagonal hole 5491 extending therethrough along the axis (L3). The threaded locking component 547 extends through the one of the second knuckles 5752 to press against the cam component 546 for locking the cam component 546 and, thus, the rod member 541 relative to the one of the second knuckles 5752.

In this embodiment, the torsion spring 521 is twisted during the door-opening process, and a restoring force of the torsion spring 521 automatically closes the door in the same manner as the second preferred embodiment.

Before the door-opening process, by inserting a hand tool into the hexagonal hole 5821 in the cam follower 582 via the internal hexagonal hole 5861 of the first enclosing bolt 586, the cam follower 582 is accessibly operable to rotate in the same manner as the second preferred embodiment so as to twist the torsion spring 521, thereby increasing the torque of the torsion spring 521. Moreover, the cam follower 582 is further accessibly operable to move in the same manner as the second preferred embodiment to untwist the torsion spring 521, thereby allowing readjustment of the torque of the torsion spring 521.

During the pivoting movement of the first leaf 571 relative to the second leaf 572, one of the first knuckles 5751 that defines the elliptical channel portion 573 is rotated relative to the rod member 541, so as to vary angular orientation of the rod member 541 relative to the elliptical channel unit 573 and, thus, the biasing force of the block-engaging spring 543 for biasing the friction-providing blocks 542 into frictional contact with the inner surrounding surface unit 579, thereby automatically adjusting the speed of the pivoting movement of the first leaf 571 relative to the second leaf 572. Moreover, by loosening the threaded locking component 547 and inserting the hand tool into the driven hole 5462 in the cam component 546 via the internal hexagonal hole 5491 of the second enclosing bolt 549, the cam component 546 is rotatable to result in axial movement of the rod member 541 away from the cam component 546 relative to the friction-providing blocks 542 through sliding movement of the protrusions 5461 of the cam component 546 relative to the cam surfaces 5415 of the rod member 541. The axial movement of the rod member 541 then results in radial and outward movement of the friction-providing blocks 542 through sliding movement of the friction-providing blocks 542 relative to the inclined outer surfaces 5413 of the rod member 541, thereby increasing friction between the friction-providing blocks 542 and the inner surrounding surface unit 579 of the knuckle unit 575. Furthermore, the cam component 546 can be further rotated reversely to permit the rod member 541 to be biased by the resilient component 545 to move toward the cam component 546 relative to the friction-providing blocks 542 to thereby decrease the friction between the friction-providing blocks 542 and the inner surrounding surface unit 579 of the knuckle unit 575. Therefore, the friction between the friction-providing blocks 542 and the inner surrounding surface unit 579 of the knuckle unit 575 can also be manually adjusted.

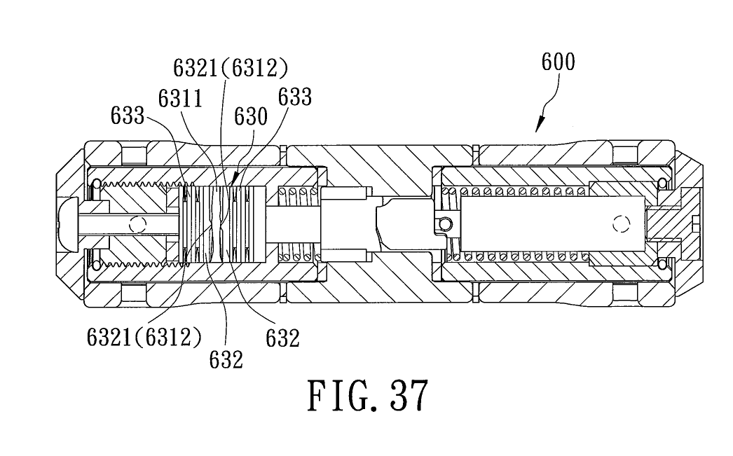

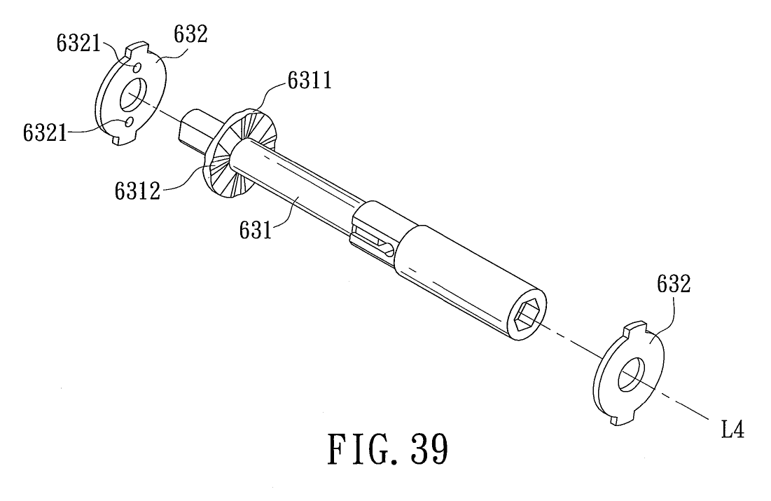

Referring to FIGS. 37 to 39, the seventh preferred embodiment of the hinge device 600 according to the present invention has a structure similar to that of the first preferred embodiment. The main difference between this embodiment and the first preferred embodiment resides in the configuration of the friction-providing unit. In this embodiment, the friction-providing unit 630 includes a flange 6311, a pair of ring plates 632, and a pair of resilient members 633. The flange 6311 projects radially and outwardly from the shaft 631 and has two side surfaces opposite to each other along an axis (L4). Each of the side surfaces is formed with a plurality of corrugations 6312 each having a plurality of alternately arranged thicker and thinner portions. The ring plates 632 are sleeved rotatably on the shaft 631. Each of the ring plates 632 has a side plate surface formed with a pair of protrusions 6321 that are rotatable to contact respectively two corresponding ones of the corrugations 6312 in a corresponding one of the side surfaces of the flange 6311. In this embodiment, each of the resilient members 633 includes a plurality of disc springs. The resilient members 633 abut resiliently and respectively against the ring plates 632.

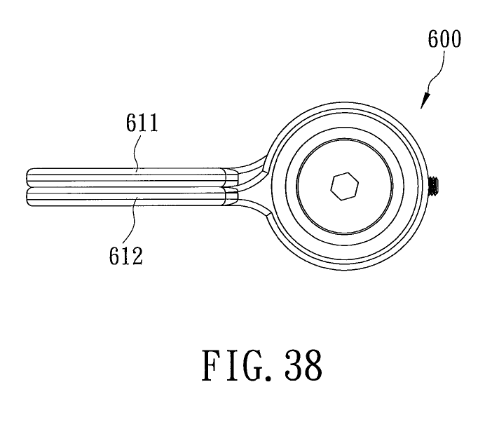

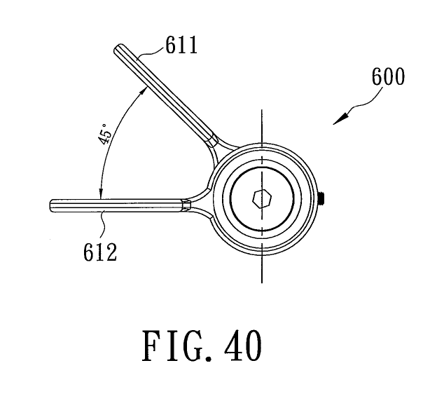

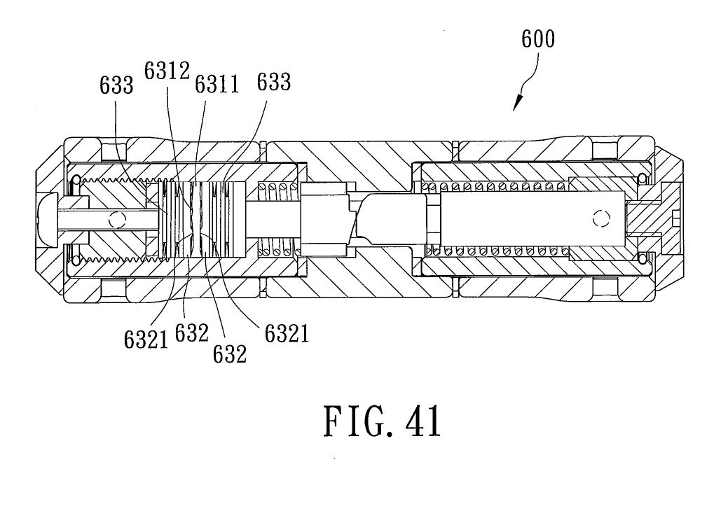

Before the door-opening process, the first leaf 611 is disposed at a zero-degree angular position (see FIG. 38) relative to the second leaf 612, where each of the protrusions 6321 of the ring plates 632 abuts against a respective one of the thicker portions of the corresponding corrugation 6312 (see FIG. 37). During the door-opening process, for example, when the first leaf 611 is pivoted from the zero-degree angular position to a 45-degree angular position (see FIG. 40) relative to the second leaf 612, the shaft 631 and the flange 6311 are rotated relative to the ring plates 632, such that each of the protrusions 6321 of the ring plates 632 slides on the corresponding corrugation 6312 from the respective one of the thicker portions of the corresponding corrugation 6312 onto a respective one of the thinner portions of the corresponding corrugation 6312 (see FIG. 41), thereby driving the ring plates 632 to move axially and resiliently toward the flange 6311 and decreasing the friction between the side surfaces of the flange 6311 and the ring plates 632 so as to speed up the pivoting movement of the first leaf 611 relative to the second leaf 612. When the first leaf 611 is further pivoted relative to the second leaf 612 from the 45-degree angular position, each of the protrusions 6321 of the ring plates 632 slides on the corresponding corrugation 6312 to abut against another thicker portion of the corresponding corrugation 6312, thereby driving the ring plates 632 to move axially away from the flange 6311 to compress the resilient members 633 and increasing the friction between the side surfaces of the flange 6311 and the ring plates 632 so as to slow down the pivoting movement of the first leaf 611 relative to the second leaf 612. Therefore, the speed of the pivoting movement of the first leaf 611 relative to the second leaf 612 can be automatically adjusted.

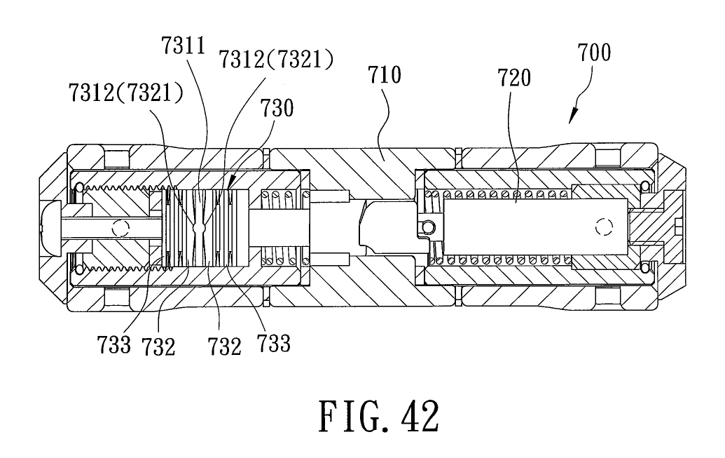

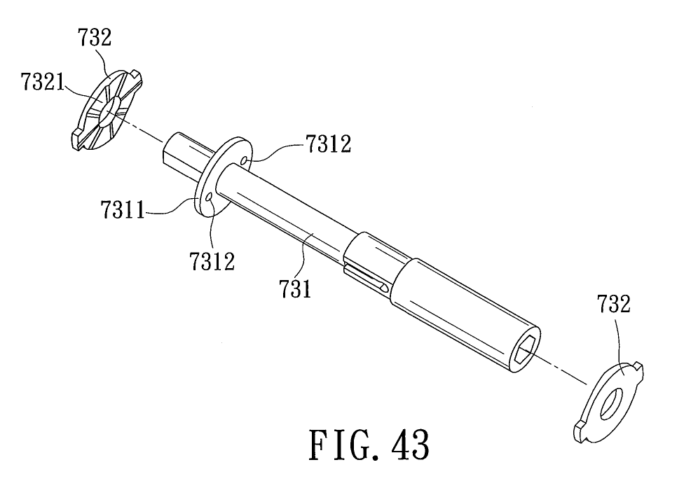

As shown in FIGS. 42 and 43, the eighth preferred embodiment of the hinge device 700 according to the invention has a structure similar to that of the seventh preferred embodiment. The main difference between this embodiment and the previous embodiment resides in the configuration of the friction-providing unit. In this embodiment, the friction-providing unit 730 includes a flange 7311, a pair of ring plates 732, and a pair of resilient members 733. Each of the side surfaces of the flange 7311 is formed with a pair of protrusions 7312. The ring plates 732 are sleeved rotatably on the shaft 731. Each of the ring plates 732 has a side plate surface formed with a plurality of corrugations 7321, each of which is rotatable to contact a corresponding one of the protrusions 7312 in a corresponding one of the side surfaces of the flange 7311.

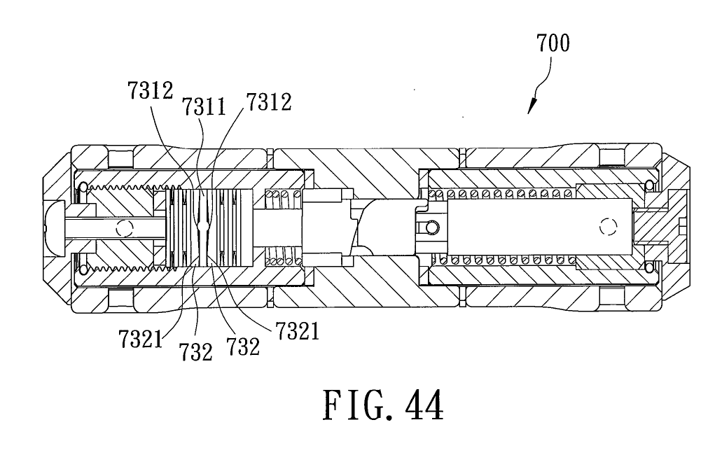

When the first leaf (not shown) is pivoted from the zero-degree angular position (see FIG. 42) to the 45-degree angular position (see FIG. 44) relative to the second leaf (not shown), the shaft 731 and the flange 7311 are rotated relative to the ring plates 732 to decrease the friction between the side surfaces of the flange 7311 and the ring plates 732 in the same manner as the previous embodiment. Likewise, when the first leaf are further pivoted relative to the second leaf, the shaft 731 and the flange 7311 is further rotated relative to the ring plates 732 from the 45-degree angular position to increase the friction between the side surfaces of the flange 7311 and the ring plates 732 in the same manner as the previous embodiment.

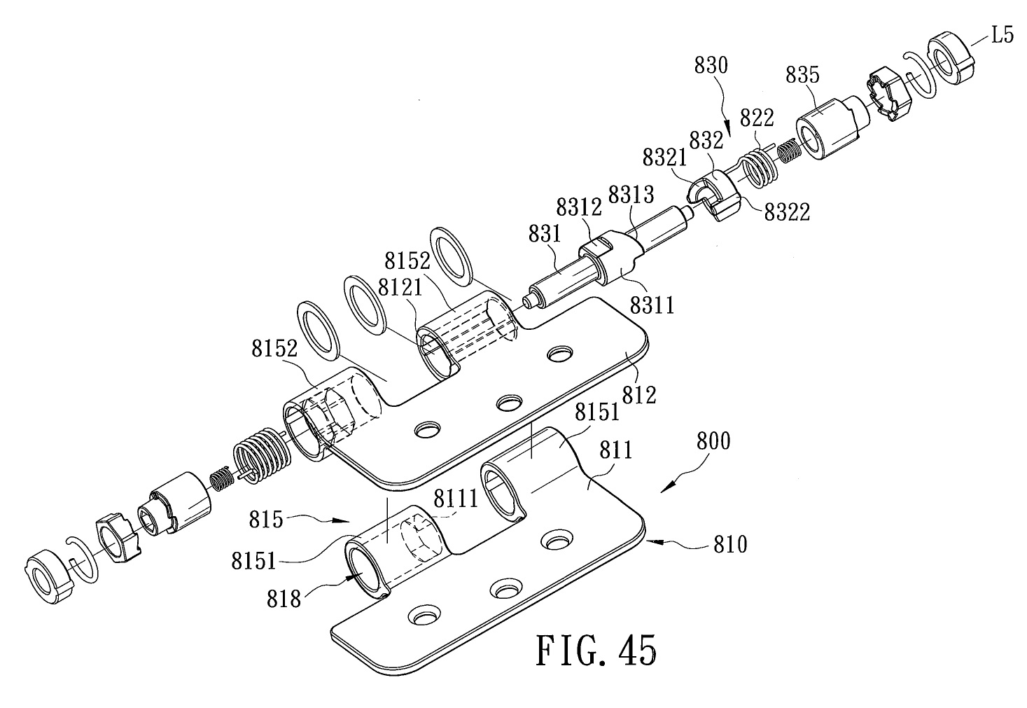

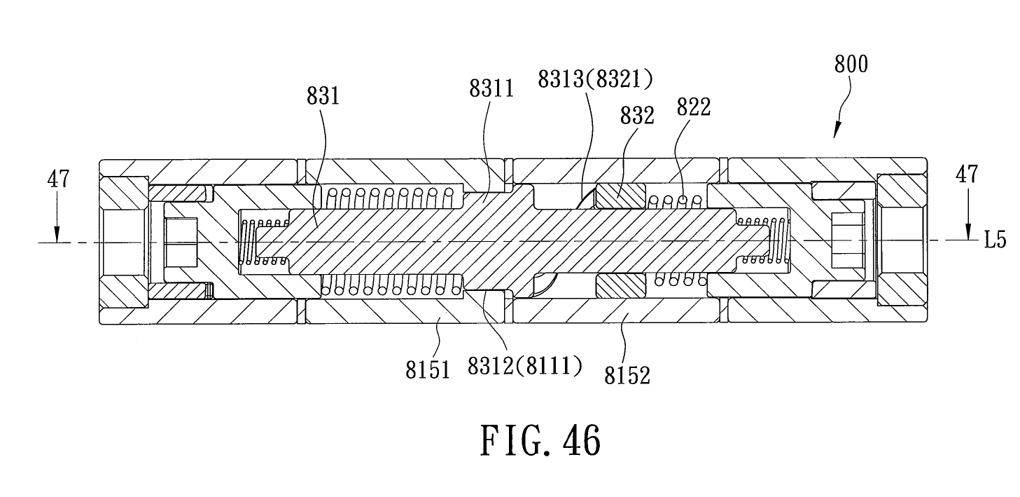

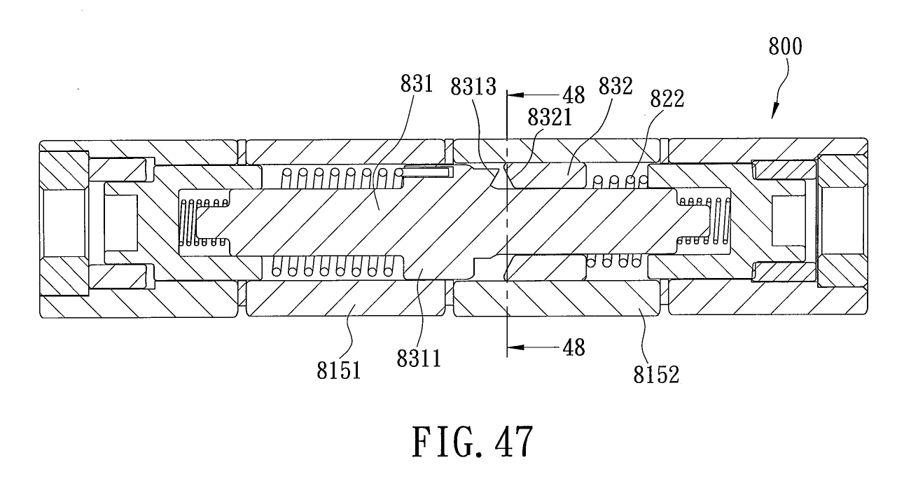

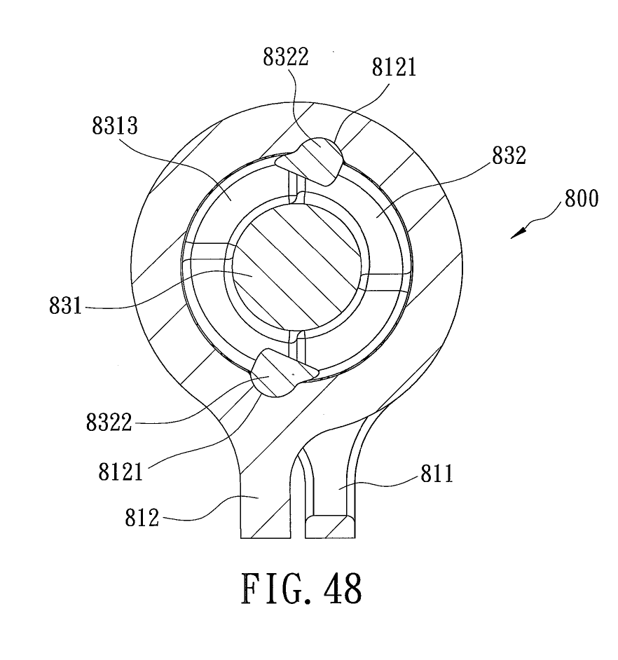

Referring to FIGS. 45 to 48, the ninth preferred embodiment of the hinge device 800 according to the invention has a structure similar to that of the sixth preferred embodiment. The main difference between this embodiment and the sixth preferred embodiment resides in the following. In this embodiment, the hinge unit 810 includes first and leaves 811, 812, and a knuckle unit 815. The knuckle unit 815 includes a pair of first knuckles 8151 provided to the first leaf 811, and a pair of second knuckles 8152 provided to the second leaf 812. The knuckle unit 815 has an inner surrounding surface unit defining a channel unit 818 therein. In this embodiment, a portion of the channel unit 818 that is within one of the first knuckles 8151 is an engaging channel portion 8111. A portion of the inner surrounding surface unit that corresponds to one of the second knuckles 8152 is formed with a pair of slide grooves 8121, each of which extends parallel to the axis (L5). The shaft 831 of the torque-adjusting unit 800 extends in the channel unit 818 along the axis (L5), and includes a cam member 8311 sleeved securely thereon. The cam member 8311 has an engaging portion 8312 inserted fittingly into the engaging channel portion 8111 such that the shaft 831 is coupled co-rotatably to the first leaf 811, and is formed with a pair of angularly equidistant first spiral surfaces 8313 opposite to the engaging portion 8312 along the axis (L5). The friction-providing unit 830 includes a cam component 832, an abutment component 835, and a resilient member 822. The cam component 832 is disposed in the channel unit 818 and is sleeved movably on the shaft 831. The cam component 832 is formed with a pair of slide ribs 8322 protruding therefrom, extending parallel to the axis (L5), and engaging respectively and slidably the slide grooves 8121, such that the cam component 832 is axially slidable relative to the one of the second knuckles 8152, and is not permitted to rotate relative to the one of the second knuckles 8152. The cam component 832 is formed with a pair of second spiral surfaces 8321 contacting slidably and respectively the first spiral surfaces 8313. The abutment component 835 is disposed in the channel unit 818 and is coupled co-rotatably to the first leaf 811. The resilient member 822 has opposite ends abutting resiliently and respectively against the cam component 832 and the abutment component 835. When the first leaf 811 is pivoted relative to the second leaf 812, the first knuckles 8151 are rotatable relative to the second knuckles 8152, and the shaft 831 is rotated to drive the cam component 832 to move toward the abutment component 835 along the axis (L5) via sliding movement of the first and second spiral surfaces 8313, 8321 on each other, thereby compressing the resilient member 822 and increasing friction between the resilient member 822 and the abutment component 835 so as to slow down the pivoting movement of the first leaf 811 relative to the second leaf 812.

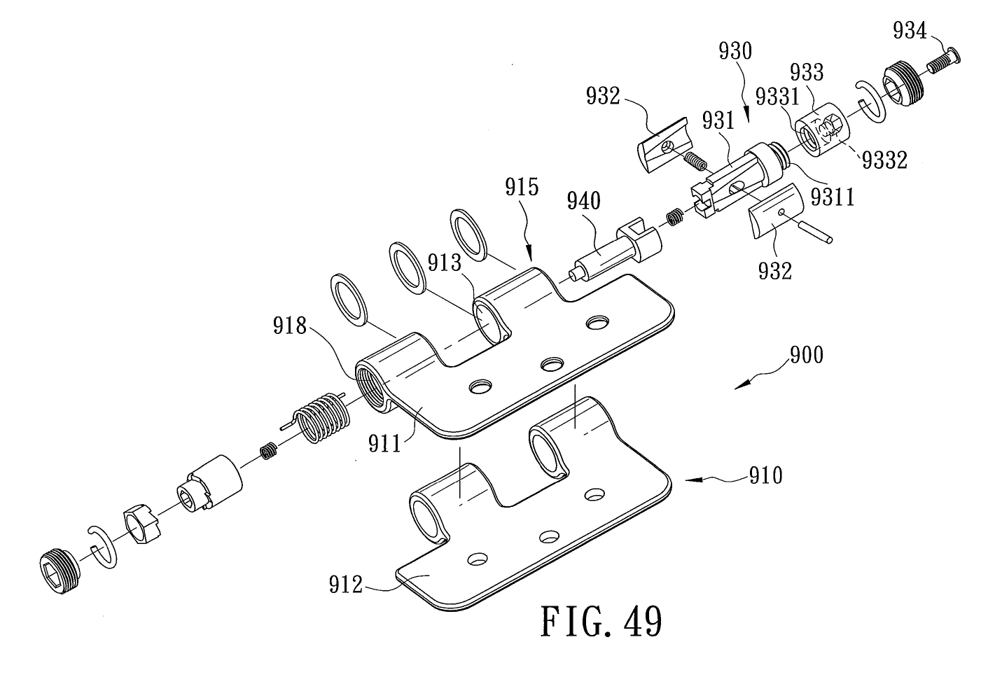

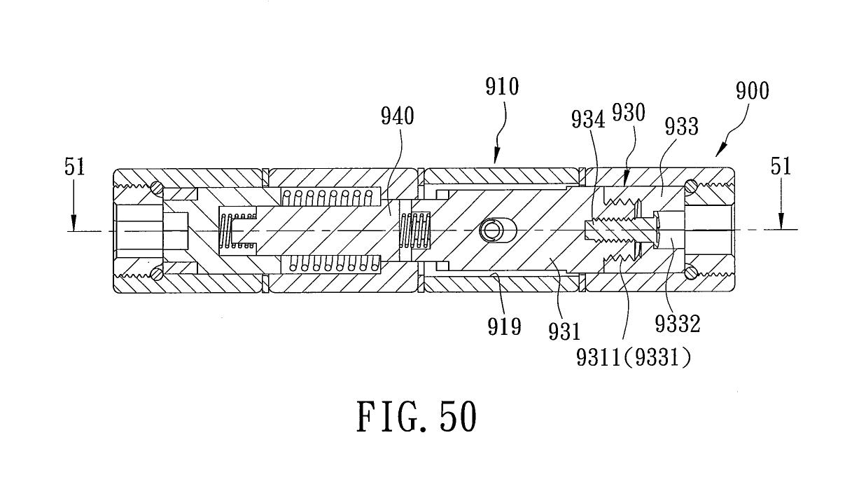

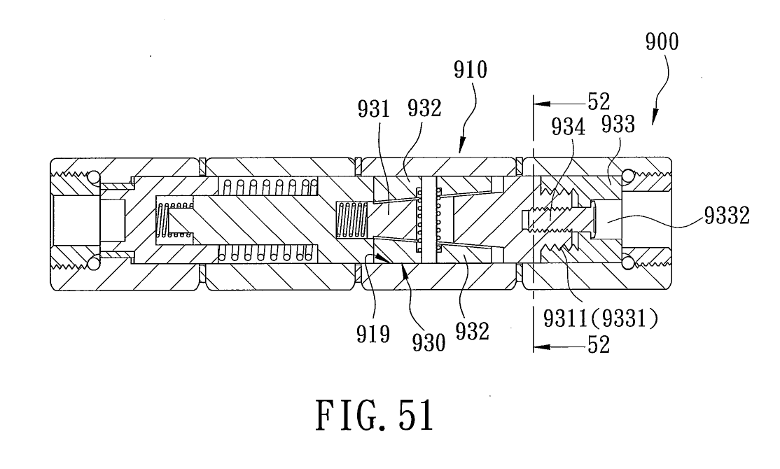

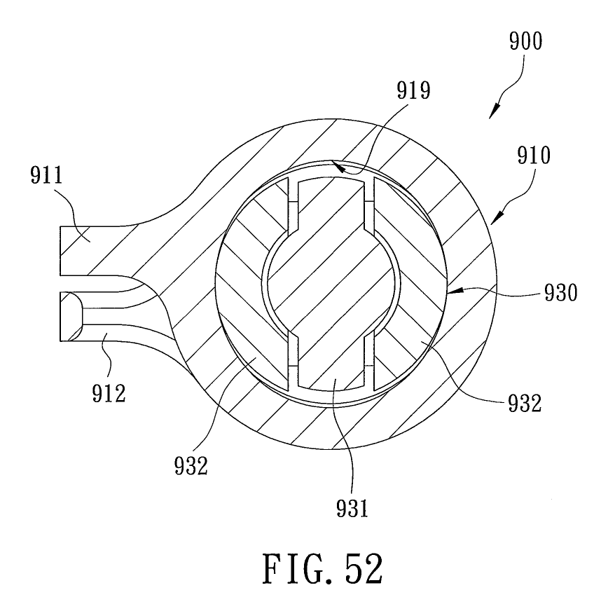

As shown in FIGS. 49 to 52, the tenth preferred embodiment of the hinge device 900 according to the present invention has a structure similar to that of the sixth preferred embodiment. In this embodiment, the knuckle unit 915 of the hinge unit 910 has an inner surrounding surface unit 919 defining a channel unit 918 therein. A portion of the channel unit 918 is an elliptical channel portion 913. The friction-providing unit 930 includes a rod member 931, and a pair of friction-providing blocks 932 that are disposed movably and respectively at diametrically opposite sides of the rod member 931, and that are biased resiliently and outwardly to move into frictional contact with the inner surrounding surface unit 919. During the pivoting movement of the first leaf 911 relative to the second leaf 912, angular orientation of the rod member 931 relative to the elliptical channel portion 913 varies to result in a change of friction between the friction-providing blocks 932 and the inner surrounding surface unit 919 in the same manner as the sixth preferred embodiment, thereby automatically adjusting the speed of the pivoting movement of the first leaf 911 relative to the second leaf 912.

The main difference between this embodiment and the sixth preferred embodiment resides in the following. The rod member 931 has a threaded section 9311 formed at a longitudinal end thereof that is opposite to the shaft 940. The friction-providing unit 930 further includes a threaded component 933 and a driven member 934. The threaded component 933 has an end that is formed with a threaded hole 9331 for engaging threadedly the threaded section 9311 of the rod member 931, and an opposite end that is formed with a hexagonal hole 9332. The driven member 934 has one end extending through the hexagonal hole 9332 and engaging threadably the threaded component 933. By removing the driven member 934 and inserting a hand tool into the hexagonal hole 9332 in the threaded component 933, the threaded component 933 is operable to move axially together with the rod member 931 relative to the friction-providing blocks 932, thereby adjusting friction between the friction-providing blocks 932 and the inner surrounding surface unit 919.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A hinge device comprising:
a hinge unit including a first leaf, a second leaf, and a knuckle unit that includes first and second knuckles provided respectively to said first and second leaves and coupled pivotally to each other such that said first leaf is pivotable relative to said second leaf, said first and second knuckles defining cooperatively a channel unit that extends along an axis;
a torque-providing unit including a torsion spring that is disposed in said channel unit, and that has a first end secured to said second knuckle and a second end opposite to said first end; and
a torque-adjusting unit including a cam mechanism that includes
a cam coupled co-rotatably to said first knuckle, and
a cam follower disposed rotatably in said first knuckle, and coupled co-rotatably to said second end of said torsion spring of said torque-providing unit;
wherein, upon application of a force, said first knuckle and said cam are rotatable in a first rotational direction relative to said second knuckle so as to drive said cam to engage said cam follower and to drive said cam follower to rotate in the first rotational direction, thereby twisting said torsion spring;
wherein, when the force is released, said cam follower is driven by a restoring force of said torsion spring to rotate in a second rotational direction opposite to the first rotational direction so as to drive said cam to rotate in the second rotational direction, thereby driving said first knuckle to rotate in the second rotational direction relative to said second knuckle; and
wherein said cam follower is operable to rotate in the first rotational direction so as to twist said torsion spring.

2. The hinge device as claimed in claim 1, wherein said hinge unit further includes a spacer component disposed between said first and second knuckles.

3. The hinge device as claimed in claim 1, wherein said torque-providing unit further includes:
a barrel extended in said first and second knuckles of said hinge unit and disposed for receiving said torsion spring therein;
a positioning nut disposed in said barrel, secured to said first end of said torsion spring, and having an outer surrounding surface that is formed with a threaded positioning hole; and
a threaded limiting component extending threadedly through said threaded positioning hole in said positioning nut for maintaining said positioning nut at an axial position relative to said barrel.

4. The hinge device as claimed in claim 3, wherein said barrel has an inner surface formed with an annular groove unit, and said positioning nut has an outer surface formed with an annular groove unit, said torque-providing unit further including a C-ring that is disposed in said barrel, and that engages said annular groove unit in said inner surface of said barrel and said annular groove unit in said outer surface of said positioning nut for retaining said positioning nut within said barrel.

5. The hinge device as claimed in claim 3, wherein:
said barrel of said torque-providing unit is formed with a through hole registered with said threaded positioning hole in said positioning nut of said torque-providing unit;
said knuckle unit is formed with a groove registered with said threaded positioning hole in said positioning nut and said through hole in said barrel and extending circumferentially by a predetermined angle; and
said threaded limiting component of said torque-providing unit has one end opposite to said positioning nut and extending outwardly of said groove via said through hole.

6. The hinge device as claimed in claim 1, wherein said torque-providing unit includes an enclosing component disposed at an end of said first and second knuckles, and an enclosing bolt extending through said enclosing component.

7. The hinge device as claimed in claim 1, wherein said cam mechanism of said torque-adjusting unit further includes a resilient component disposed for biasing resiliently said cam toward said cam follower.

8. The hinge device as claimed in claim 1, wherein:
said torque-adjusting unit further includes a shaft that extends along the axis in said channel unit, and that has a pair of shaft segments coupled co-rotatably to each other; and
one of said shaft segments is coupled co-rotatably to said cam follower, and is formed with a slot for retaining said second end of said torsion spring of said torque-providing unit therein.

9. The hinge device as claimed in claim 8, wherein said one of said shaft segments of said shaft of said torque-adjusting unit has a coupling end portion coupled co-rotatably to said cam follower of said cam mechanism of said torque-adjusting unit, and a driven end portion opposite to said coupling end portion and accessible so that said shaft is capable of being driven to rotate in the first rotational direction.

10. The hinge device as claimed in claim 9, wherein said driven end portion of said shaft is formed with an accessible tool driven hole.

11. The hinge device as claimed in claim 8, further comprising a friction-providing unit including a friction-providing component that is provided on said shaft of said torque-adjusting unit, a resilient member, and an adjusting component that is movable toward said friction-providing component for driving said resilient member to abut resiliently against said friction-providing component to thereby result in friction against the rotation of said shaft.

12. The hinge device as claimed in claim 11, wherein said friction-providing component includes:
a flange projecting radially and outwardly from said shaft, and having opposite side surfaces;
a pair of protrusions protruding respectively from said side surfaces of said flange; and
a pair of brake plates disposed respectively at opposite sides of said flange and biased by said resilient member to press respectively against said protrusions.

13. The hinge device as claimed in claim 11, wherein said resilient member of said friction-providing unit is a compression spring.

14. The hinge device as claimed in claim 11, wherein said resilient member of said friction-providing unit includes at least one disc spring.

15. The hinge device as claimed in claim 11, wherein said adjusting component of said friction-providing unit is formed with an accessible driven hole so that said adjusting component is capable of being driven to move toward and away from said friction-providing component.

16. The hinge device as claimed in claim 11, wherein said friction-providing unit further includes:
a barrel which is extended in said first and second knuckles of said hinge unit, which is formed with a threaded hole, and within which said adjusting component is disposed; and
a threaded limiting member which extends threadedly through said threaded hole in said barrel to press against said adjusting component for locking said adjusting component relative to said barrel.

17. The hinge device as claimed in claim 16, wherein said barrel has an inner surface formed with an annular groove unit, and said positioning nut has an outer surface formed with an annular groove unit, said friction-providing unit further including a C-ring that is disposed in said barrel, and that engages said annular groove unit in said inner surface of said barrel and said annular groove unit in said outer surface of said positioning nut for retaining said adjusting component within said barrel.

18. The hinge device as claimed in claim 16, wherein:
said knuckle unit is formed with a groove registered with said threaded hole in said barrel and extending circumferentially by a predetermined angle; and
said threaded limiting member of said friction-providing unit has one end opposite to said adjusting component and extending outwardly of said groove via said threaded hole.

19. The hinge device as claimed in claim 1, wherein:
said cam follower of said torque-adjusting unit is secured to said second end of said torsion spring of said torque-providing unit, and is formed with an accessible hexagonal hole;
wherein said cam follower is accessibly operable to rotate in the first rotational direction so as to twist said torsion spring; and
wherein said cam follower is further accessibly operable to move away from said cam so as to untwist said torsion spring.

20. The hinge device as claimed in claim 1, wherein:
said knuckle unit has an inner surrounding surface unit defining said channel unit therein;
a portion of said channel unit is formed as an elliptical channel portion; and
said hinge device further comprises a friction-providing unit including a rod member that extends along the axis in said portion of said channel unit, a pair of friction-providing blocks that are disposed movably and respectively at diametrically opposite sides of said rod member, and a block-engaging spring that extends transversely through said rod member and that has opposite ends connected respectively to said friction-providing blocks for biasing resiliently and outwardly said friction-providing blocks to move into frictional contact with said inner surrounding surface unit of said knuckle unit.

21. The hinge device as claimed in claim 20, wherein said friction-providing unit further includes a coupling block secured to said second knuckle of said knuckle unit and said rod member of said friction-providing unit such that angular orientation of said rod member relative to said elliptical channel portion of said knuckle unit varies during the pivoting movement of said first leaf relative to said second leaf.

22. The hinge device as claimed in claim 20, wherein:
said rod member of said friction-providing unit has a pair of inclined outer surfaces which are formed respectively at diametrically opposite sides thereof, a cam surface which is formed at a longitudinal end thereof, and an elongated through hole which extends transversely through said inclined outer surfaces, which has a width larger than that of said block-engaging spring, and through which said block-engaging spring extends such that said rod member is axially movable relative to said friction-providing blocks;
said friction-providing unit further includes a cam component which abuts rotatably against said cam surface of said rod member; and
said cam component is rotatable to result in axial movement of said rod member relative to said friction-providing blocks so as to urge radially and outwardly said friction-providing blocks to thereby increase friction between said friction-providing blocks and said inner surrounding surface unit of said knuckle unit during pivoting movement of said first leaf relative to said second leaf.

23. The hinge device as claimed in claim 20, wherein:
said rod member of said friction-providing unit has a pair of inclined outer surfaces which are formed respectively at diametrically opposite sides thereof, a threaded section which is formed at a longitudinal end thereof, and an elongated through hole which extends along the axis and through said inclined outer surfaces, and through which said block-engaging spring extends such that said rod member is axially movable relative to said friction-providing blocks;
said friction-providing unit further includes a threaded component which engages threadedly said threaded section of said rod member; and
said threaded component is operable to move axially together with said rod member relative to said friction-providing blocks so as to urge radially and outwardly said friction-providing blocks to thereby increase friction between said friction-providing blocks and said inner surrounding surface unit of said knuckle unit during pivoting movement of said first leaf relative to said second leaf.

24. The hinge device as claimed in claim 1, wherein said hinge unit further includes a bearing unit disposed between said first and second leaves.

25. The hinge device as claimed in claim 24, wherein said bearing unit has a plurality of roller grooves formed in an outer surrounding surface of one of said first and second knuckles, a plurality of rollers retained rotatably and respectively in said roller grooves, and a barrel member sleeved on said rollers and coupled to the other one of said first and second knuckles.

26. The hinge device as claimed in claim 24, wherein said bearing unit includes a wear-resisting ring sleeved on one of said first and second knuckles, and a barrel member sleeved rotatably on said wear-resisting ring and co-rotatable with the other one of said first and second knuckles.

27. The hinge device as claimed in claim 8, further comprising a friction-providing unit including:
a flange projecting radially and outwardly from said shaft of said torque-adjusting unit, and having two side surfaces opposite to each other along the axis;
a pair of ring plates sleeved rotatably on said shaft and contacting respectively said opposite side surfaces of said flange; and
a pair of resilient members abutting resiliently and respectively against said ring plates for pressing said ring plates against said flange;
wherein said shaft is rotatable to result in axial movements of said ring plates, thereby compressing resiliently said resilient members so as to increase friction between said side surfaces of said flange and said ring plates.

28. The hinge device as claimed in claim 27, wherein:
each of said side surfaces of said flange of said torque-adjusting unit is formed with a plurality of corrugations; and
each of said ring plates has a side plate surface formed with a pair of protrusions that are rotatable to contact respectively two corresponding ones of said corrugations in a corresponding one of said side surfaces of said flange.

29. The hinge device as claimed in claim 27, wherein:
each of said side surfaces of said flange of said torque-adjusting unit is formed with a pair of protrusions; and
each of said ring plates has a side plate surface formed with a plurality of corrugations each rotatable to contact a corresponding one of said protrusions in a corresponding one of said side surfaces of said flange.

30. The hinge device as claimed in claim 8, wherein:
said torque-adjusting unit further includes a shaft extending along the axis in said channel unit, coupled co-rotatably to said first leaf and formed with a first spiral surface; and
said hinge device further comprises a friction-providing unit including
a cam component disposed in said channel unit, slidable along the axis, coupled co-rotatably to said second leaf, and formed with a second spiral surface contacting slidably said first spiral surface,
an abutment component disposed in said channel unit and coupled co-rotatably to said first leaf, and
a resilient member having opposite ends abutting resiliently and respectively against said cam component and said abutment component for biasing said second spiral surface to contact said first spiral surface, said shaft of said torque-adjusting unit being rotatable to drive said cam component to move toward said abutment component along the axis through sliding movement of said first and second spiral surfaces on each other, thereby compressing said resilient member and increasing friction between said resilient member and said abutment component during pivoting movement of said first leaf relative to said second leaf.
